(19) United States
(12) Patent Application Publication
(10) Pub. No.: US 2026/0278521 A1
(43) Pub. Date: Sep. 17, 2026

(54) SENSORIZED SHIPPING CONTAINER GEOFENCING SYSTEMS AND METHODS

(71) Applicant: Cryoport, Inc., Brentwood, TN (US)

(72) Inventors: Quang Nguyen, Huntington Beach, CA (US); Bret Bollinger, Yorba Linda, CA (US); Quinn Waddell, Rogers, AR (US); Bobby Onel, Laguna Beach, CA (US); Pratik Khetiya, Irvine, CA (US); Phil Schlesinger, Mission Viejo, CA (US); Mike Dybicz, Nashville, TN (US)

(73) Assignee: Cryoport, Inc., Brentwood, TN (US)

(21) Appl. No.: 19/560,018

(22) Filed: Mar. 7, 2026

Related U.S. Application Data
(60) Provisional application No. 63/772,314, filed on Mar. 14, 2025.

(51) Int. Cl. G06Q 10/0833

(52) U.S. Cl. CPC G06Q 10/0833

(57) ABSTRACT

Systems and methods for tracking a shipment can include a data logger and a location sensor located onboard a shipping container. The data logger can have one or more Geofences stored thereon that allows the data logger to detect Geofence activity violations and send updates to a remote monitoring unit (e.g., a fleet management server system or the like) depending on the shipping container's detected location with respect to the one or more Geofences. The Geofence can have an entry radius and an exit radius. An entry into the Geofence boundary can be detected in response to the shipping container crossing the Geofence entry radius. An exit out of the Geofence boundary can be detected in response to the shipping container crossing the Geofence exit radius. The entry radius can be different from the exit radius.

### CROSS REFERENCE TO RELATED APPLICATION

This application is based upon and claims the benefit of and priority to U.S. Provisional Patent Application No. 63/772,314 entitled “SENSORIZED SHIPPING CONTAINER GEOFENCING SYSTEMS AND METHODS,” filed on Mar. 14, 2025, the entire content of which is incorporated by reference herein.

### FIELD OF INVENTION

The present disclosure relates to systems, methods, and programs for tracking a shipping container and more specifically, to systems, methods, and programs to provide electronic data corresponding to the monitored shipping container location.

### BACKGROUND

Traditional location tracking systems generally either provide global location tracking using global positioning systems (GPS) or discrete location information using radio frequency identification (RFID) or similar technology to obtain real-time data on in-transit locations. These systems typically enable monitoring and management of various inventory systems. Unfortunately however, such real-time systems fail to provide certain information regarding shipment progress to interested persons at different global locations.

Frequently, there is a need to ship materials from one place to another place while maintaining the materials in environmentally controlled conditions. For instance, there is a need to maintain the materials at a specific temperature range. However, unexpected delays and other occurrences during shipping may lead to the materials being exposed to environmental conditions outside a desired range. For example, material may be shipped in a cryogenic shipping container having a Dewar with one or more cooling agent, such as liquid nitrogen therein. Over time, the cooling agent may dissipate, causing the materials to begin warming and the temperature of the materials to change, potentially exceeding the specific temperature range. Thus, there remains a need to remotely track the location and progress of the shipping container and provide various alerts to a remote operator of these conditions.

### SUMMARY

Systems, methods, and articles of manufacture (collectively “the system”) are disclosed for electronically tracking the progress of a shipping container during shipment. The system may electronically monitor the location of the shipping container during shipment and may determine whether the location has violated any of the stored Geofence entry and/or exit activities. The system may compare the Geofence boundaries with the location data to determine if the progress of the shipment and report Geofence activity violation to a remote server. In some aspects the system compares the present location with the most recently recorded location of the shipping container to determine whether a Geofence activity has been violated (i.e., whether the shipping container has entered and/or exited a Geofence boundary). In this manner, the system facilitates location monitoring and tracking over the shipping journey.

### BRIEF DESCRIPTION OF THE DRAWINGS

The subject matter of the present disclosure is particularly pointed out and distinctly claimed in the concluding portion of the specification. However, a more complete understanding of the present disclosure may be obtained by referring to the detailed description and claims when considered in connection with the drawing figures, wherein the numerals denote like elements.

A more complete understanding may be derived by referring to the detailed description and claims when considered in connection with the Figures, wherein like reference numbers refer to similar elements throughout the Figures, and:

FIG. 1 is a block diagram illustrating the electronic tracking system, in accordance with various embodiments.

FIG. 2 is a flowchart illustrating the method of electronic shipment tracking, in accordance with various embodiments.

FIG. 3 is a diagram illustrating a Geofence with symmetric entry and exit radii, in accordance with various embodiments.

FIG. 4 is a diagram illustrating a Geofence with asymmetric entry and exit radii, in accordance with various embodiments.

FIG. 5 is a diagram illustrating a Geofence with detected shipping container locations violating a Geofence entry activity, in accordance with various embodiments.

FIG. 6 is a diagram illustrating a Geofence with detected shipping container locations violating a Geofence exit activity, in accordance with various embodiments.

FIG. 7 is a diagram illustrating a Geofence with detected shipping container locations violating a Geofence exit activity, in accordance with various embodiments.

FIG. 8 is a diagram illustrating a two-leg shipment with detected shipping container locations and the same start and finish locations, in accordance with various embodiments.

FIG. 9 is a diagram illustrating a two-leg shipment with detected shipping container locations and different start and finish locations, in accordance with various embodiments.

FIG. 10 is a diagram illustrating a three-leg shipment with detected shipping container locations and the same start and finish locations, in accordance with various embodiments.

FIG. 11 is a diagram illustrating a four-leg shipment with detected shipping container locations and the same start and finish locations, in accordance with various embodiments.

FIG. 12 is a diagram illustrating a four-leg shipment across an international border with detected shipping container locations and the same start and finish locations, in accordance with various embodiments.

FIG. 13 is a flowchart illustrating the method of electronic shipment tracking, in accordance with various embodiments.

FIG. 14 is a flowchart illustrating a method of electronic shipment tracking and reporting, in accordance with various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized, and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Disclosed herein are systems, methods, and apparatuses for improving shipment tracking. Particular embodiments of the subject matter described in this disclosure may be implemented to realize one or more of the following advantages. A shipping container tracking system can be configured to detect and report Geofence entry and/or exit violations which can be used to notify when a shipment has arrived at its destination and/or when it has left its origin. In various embodiments, the tracking system of the present disclosure can be used for tracking any internet of things (IOT) device capable of tracking its location and communicating with a central server system. The tracking system can be further configured to perform various actions in response to detecting a Geofence entry and/or Geofence exit violation. For example, if the Geofence is an airport-type Geofence, the tracking system can activate an Aircraft Mode when entering the Geofence and can deactivate the Aircraft Mode when exiting the Geofence. While reference is made to an “Aircraft Mode” throughout this document, the so-called “Aircraft Mode” may not be an aircraft-specific mode, but may be any change in operating method, procedure, rules, etc. specific to presence in a particular area. For instance, the “Aircraft Mode” may include inhibiting one or more transmitter and/or changing a frequency or duty cycle of a transmitter. The “Aircraft Mode” may be operable in response to presence in certain geographic regions with regulatory or other limitations on operations. Moreover, detecting a Geofence entry and/or Geofence exit violation may be indicated manually by a button press, or over-the-air signal, in addition to being detected by a location tracking aspect of a system.

As used herein, the term “fence,” “fences,” and/or “fencing” means regions either inside or outside a planned shipping location or route where the system is configured to take a specific action. As used herein, the term “Geofence” is defined as a data structure having the following information: (i) name, (ii) latitude, (iii) longitude, (iv) radius, and (v) activity (e.g., entry or exit). In various embodiments, the data structure can further have a (vi) location type (e.g., leg, waypoint, airport, etc.). In various embodiments, the data structure can further have an (vii) airport code such as an ICAO (International Civil Aviation Organization) code and/or an IATA (International Air Transport Association) code.

In the Figures and the following more detailed description, numerals indicate various features of the invention, with like numerals referring to like features throughout both the drawings and the description.

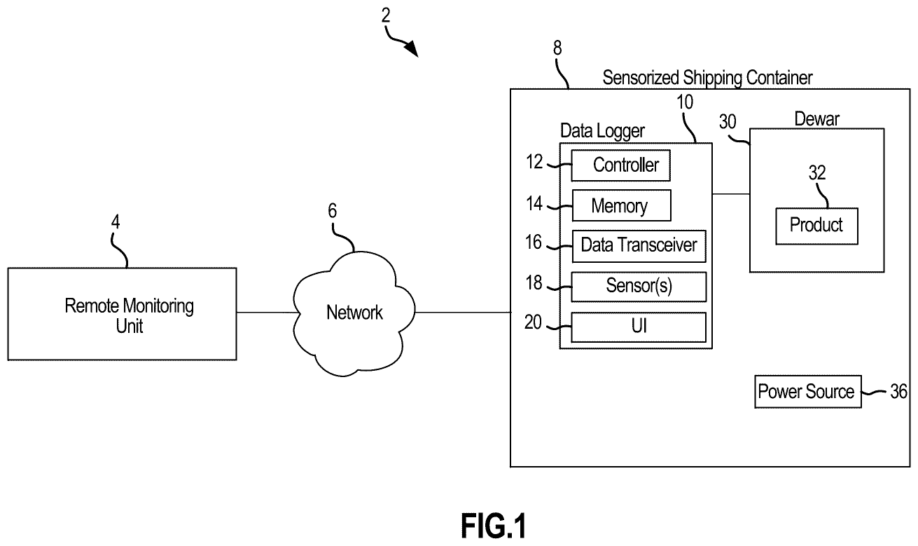

Now, with reference to FIG. 1, an electronic tracking system 2 is provided. This electronic tracking system 2 may operate to electronically monitor and/or track one or more shipping containers as the shipping container(s) travels along between two or more locations. The electronic tracking system 2 may be particularly useful for sensitive materials, such as temperature-sensitive materials, where active tracking and monitoring of the sensitive material is desirable. The electronic tracking system 2 can be used to monitor and/or track a shipping container during shipment and provide alerts corresponding to measurements taken by sensors during the electronic monitoring and/or configure the shipping container electronics for various legs or segments of the shipment. For example, a remote monitoring unit 4 may communicate with aspects of a sensorized shipping container 8 over a network 6. An internet of things device, such as a data logger 10, can be used to monitor aspects of the shipping container 8 and/or its contents. In the illustrated embodiment, the shipping container includes a Dewar 30 and a product 32; however, aspects of the present disclosure can be used for tracking/monitoring/configuring a sensorized shipping container 8 having any suitable item(s). The data logger 10 can communicate with the remote monitoring unit 4 to alert the remote monitoring unit 4 of the location of the sensorized shipping container 8. Various methods discussed further herein will facilitate the detection of Geofence activity violations, such as when the shipping container 8 enters and/or exits a virtual Geofence.

With continuing reference to FIG. 1, the electronic tracking system 2 may include the remote monitoring unit 4. In various embodiments, the remote monitoring unit 4 may be a computerized monitoring unit that is external to the shipping container 8. The remote monitoring unit 4 may be used to remotely monitor various parameters (e.g., location, temperature, humidity, pressure, altitude, location, orientation, acceleration, light exposure, etc.) of the shipping container and its contents. As used herein, pressure may refer to an air pressure. Pressure may refer to a barometric pressure. The remote monitoring unit 4 can be a fleet management server system, in accordance with various embodiments.

Moreover, the electronic tracking system may include a network 6. The network 6 may provide two-way data communication that can include a local network, a wide area network, or some combination of the two. For example, an integrated services digital network (ISDN) may be used in combination with a local area network (LAN). In another example, a LAN may include a wireless link. A network link typically provides data communication through one or more networks to other data devices. For example, a network link may provide a connection through a local network to a host computer or to a wide area network such as the Internet. A local network and the Internet may both use electrical, electromagnetic, or optical signals that carry digital data streams. A computing system may use one or more networks to send messages and data, including program code and other information.

The electronic tracking system may include the sensorized shipping container 8.

The sensorized shipping container 8 may be a sensorized shipping container 8 designed to store contents at cryogenic temperatures. In various embodiments, the sensorized shipping container 8 may contain a plurality of components designed to perform various electronic monitoring steps.

With continuing reference to FIG. 1, the sensorized shipping container 8 may include a variety of associated components. For example, the sensorized shipping container may include the data logger 10. The data logger 10 can be a computerized data logger that is external or internal to the shipping container 8. For example, the data logger 10 can be mounted in, on, or adjacent to the shipping container 8. The data logger 10 can be used to monitor various parameters (e.g., temperature, humidity, pressure, altitude, location, orientation, acceleration, light exposure, etc.) of the shipping container 8 and its contents. In various embodiments, the data logger 10 may contain a plurality of components deigned to perform various electronic monitoring steps.

The data logger 10 can include one or more controllers 12 (e.g., processors) and one or more memories (e.g., memory 14) capable of implementing digital or programmatic logic. In various embodiments, for example, the one or more controllers are one or more of a general purpose processor, digital signal processor (DSP), application specific integrated circuit (ASIC), field programmable gate array (FPGA), or other programmable logic device, discrete gate, transistor logic, or discrete hardware components, or any various combinations thereof or the like. In various embodiments, the data logger 10 monitors at least various parts of the sensorized shipping container 8 and/or its contents. For example, the data logger 10 monitors, records, annotates, evaluates, and/or transmits various sensor readings of the sensorized shipping container 8 and/or the Dewar 30.

The memory 14 may include one or more of random access memory (“RAM”), static memory, cache, flash memory and any other suitable type of storage device that can be coupled to a bus or other communication mechanism. The memory 14 can be a tangible, non-transitory memory. In various embodiments, the memory 14 and the one or more controllers 12 may be fabricated in a common device and/or collocated in a common package. The memory 14 can be used for storing instructions and data that can cause the one or more controllers 12 to perform a desired process. The memory 14 may be used for storing transient and/or temporary data such as variables and intermediate information generated and/or used during execution of the instructions by processor. The memory 14 may comprise one or more separate non-volatile storage device, such as read only memory (“ROM”), flash memory, memory cards or the like. The memory 14 may be connected to a data transceiver 16 or other communication mechanism. The memory 14 can be used for storing configuration, Geofences, and other information, including instructions executed by controller 12.

The data logger 10 and/or the sensorized shipping container 8 may include a data transceiver 16. The data transceiver 16 may be a data communication device, a wireless transceiver, radio transmitter or any other form of data transceiver. In various embodiments, the data transceiver 16 may be configured to transmit and/or receive data between the sensorized shipping container 8 and the remote monitoring unit 4. In various embodiments, the data transceiver 16 may be configured to transmit and/or receive data between the data logger 10 and the remote monitoring unit 4. In various embodiments, the data transceiver 16 may be configured to transmit and/or receive data via the network 6. In various embodiments, the data transceiver 16 may be configured to both transmit and receive data. In various embodiments, the data transceiver 16 may configured to only transmit data or only receive data. In various embodiments, the data transceiver 16 may be a high-speed universal serial bus (USB), Firewire or other such communication mechanism.

The data logger 10 can include one or more sensors 18. The controller 12 can be in communication with the one or more sensors 18 and the memory 14, wherein the controller 12 may receive sensor measurements (also referred to herein as sensor readings). The controller 12 may transmit the sensor readings to the memory 14. The one or more sensors 18 may include one or more of a temperature sensor, a shock sensor, a light sensor, an altitude sensor including but not limited to a pressure sensor, a positional sensor, a humidity sensor, and/or a battery sensor. A temperature sensor may include a thermocouple wire configured to measure temperature, or an optical temperature sensor, or any other component configured to measure temperature. A shock sensor may include an accelerometer or gyroscope or any other sensor configured to measure orientation or movement. A shock sensor can be configured to measure the movement of the shipping container 8, including the speed of rotation. A shock sensor may measure the rotation on one or more axes. A light sensor can be configured to detect and and/or measure light intensity. A number of different types of light sensors can be used. For example, the light sensor can include a photovoltaic light sensor, a photoresistor light sensor, a photoconductive light sensor, or another suitable light sensor. A light sensor can be used to detect whether one or more components of the sensorized shipping container 8 (e.g., a vapor plug and/or a Dewar lid) has been opened and thereby exposed to a light source. An altitude sensor can be configured to measure air pressure (e.g., a barometric sensor). A humidity sensor can be configured to detect and and/or measure changes in local humidity. A number of different types of humidity sensors can be used. For example, a humidity sensor can comprise a capacitive humidity sensor, a resistive humidity, a thermal humidity sensor, or another suitable humidity sensor. A battery sensor can be configured to detect and and/or measure one or more of battery capacity (e.g., battery charge percentage), battery voltage, and/or battery cycles.

The one or more sensors 18 can include a positional sensor. The positional sensor can be configured to identify a location of the sensorized shipping container 8. A number of different types of positional sensors can be used alone or in combination with others. For example, a positional sensor can comprise one or more of a global positioning system (GPS) sensor or other satellite-based positioning system, a Wi-Fi positioning system (WPS), a cellular location positioning system (CPS), a Bluetooth positioning system (BPS), a radio-frequency identification (RFID) positioning system, or another suitable positioning system.

The sensorized shipping container 8 can further include a user interface 20. The user interface 20 can be integrated with the data logger 10 or can be a standalone device. The sensorized shipping container 8 may display shipping information, sensor data, location data, notifications, and/or other information on the user interface 20. The user interface 20 may include an input/output device that receives user input from a user interface element, a button, a dial, a microphone, a keyboard, or a touch screen. The user interface 20 may have an output device, such as a display, a speaker, an audio and/or visual indicator, a touch-screen display or a refreshable braille display. The user interface 20 can be part of the data logger 10 and/or can be in electronic communication with the data logger 10. In various embodiments, the data logger 10 can send an alert to the user interface 20 in response to detecting a Geofence activity violation as described herein. In various embodiments, the user interface 20 is a browser session operating in a separate or remotely-disposed device in electronic communication with aspects of the sensorized shipping container 8.

The sensorized shipping container 8 may include a Dewar 30 containing a product 32. A Dewar 30 may be a cryogenic storage container, such as a vacuum flask used for storing cryogenic materials. In some embodiments, a Dewar 30 may have multiple vacuum sealed walls. The Dewar 30 may be configured to hold the product 32 under cryogenic conditions (e.g., −130 degrees Fahrenheit (−90° C.) or colder). The product 32 can be a temperature-sensitive material.

The sensorized shipping container 8 may include a power source 36. For example, the power source 36 can include a battery, a solar charging device, a thermal or other energy harvesting charging device, and/or any other source of electrical power as desired. The power source 36 can be used to power the data logger 10, and/or the Dewar 30.

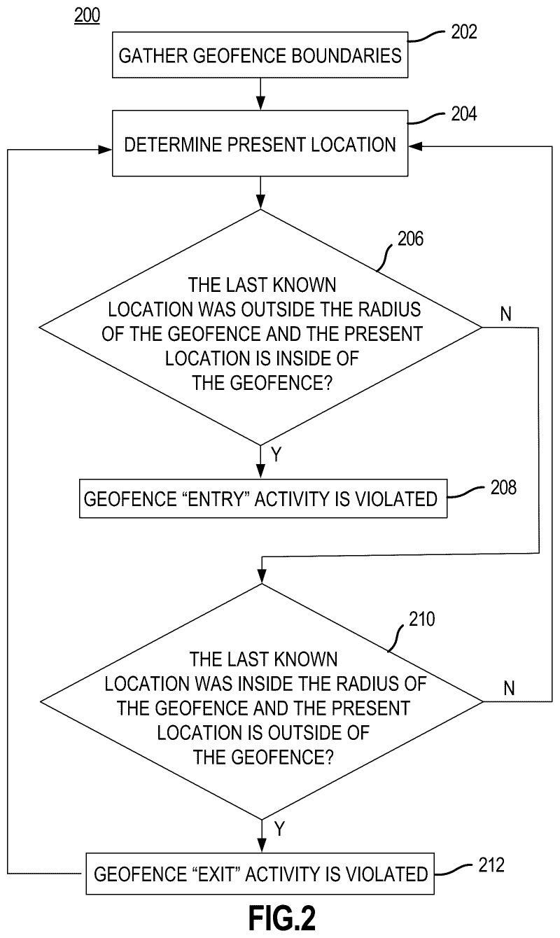

Having discussed aspects of the electronic tracking system 2, attention is now directed to a combination of FIGS. 1 and 2 for a discussion of a method 200 of electronic shipment tracking. The method 200 of electronic shipment tracking may have a variety of steps. Moreover, many of the steps discussed in this and other paragraphs herein, with respect to this, and other methods herein may be described with features occurring on a component of the sensorized shipping container and features occurring on a component of a remote computing system. However, one may appreciate that different arrangements may be contemplated and features occurring on a component of the sensorized shipping container may also or alternatively be performed by transmission of relevant data to a remote computing system, where the feature is performed. Returning to method 200, in various instances, the data logger 10 can track the location of the sensorized shipping container 8 to determine whether a Geofence activity has been violated. The data logger 10 can report the location of the shipping container 8 to the remote monitoring unit 4 (e.g., a fleet management server) as the shipment progresses throughout its journey. Moreover, the data logger 10 can perform other actions in response to the data logger 10 determining that a Geofence activity has been violated (i.e., in response to entering and/or exiting a Geofence. For example, the data logger 10 can command the user interface 20 to display a shipping label. In various embodiments, the data logger 10 can command the user interface 20 to display different types of instructions and/or information depending on the location of the shipping container 8. In various embodiments, the data logger 10 can turn on or off certain components and/or disable certain types or frequencies of communications (e.g., in proximity to an airport, during flight, and/or when inside certain communication/frequency restricted zones). For example, when an airport-type Geofence entry activity has been violated, the data logger 10 can switch to an “Aircraft Mode.” Aircraft Mode may be triggered by different mechanisms, such as a detection of a change in acceleration, or may be ended by a detection of acceleration in multiple axes going to zero and acceleration in one axis corresponding to gravity, or by a detection of changes in pressure, or detection of motion dynamics corresponding to taking off and/or landing, or by other mechanisms. Moreover, Aircraft Mode may be triggered remotely by an electronic message. Furthermore, a combination of detecting an airport-type Geofence entry activity and also detecting a change in acceleration may be implemented to determine that the data logger 10 switch to an “Aircraft Mode” while yet ameliorate possible improper switching to an Aircraft Mode in response to physical handling of the container. In various instances, a determination of an Aircraft Mode, or of a specific phase of flight may be made by evaluating a change of values (gradient) over time (acceleration and/or air-pressure). In various instances this determination is made by evaluating the mentioned change of values and not with respect to a timeline or timer-based mechanism.

Various actions can be triggered in response to the data logger 10 detecting that the shipping container has entered and/or exited difference Geofences. Moreover, the determination of entering and/or exiting different Geofences may be performed by a remote server in electronic communication with the data logger 10. In various embodiments, the data logger 10 can switch from a first frequency to a second frequency for wireless data transmission, for example using the data transceiver 16, in response to entering and/or exiting a Geofence boundary. In various embodiments, the data logger 10 can switch among different sensors, and/or change aspects of one or more sensor, such as sensing/polling rate or acceptable value ranges, in response to entering and/or exiting a Geofence boundary. The data logger 10 may also or alternatively receive instructions to perform one or more of these actions such as via a radio transmission, or by a button press.

Table 1 below includes example Geofence names and activities for leg-type Geofences.

TABLE 1
Name and Activity for Leg-type Geofences

| | | Electronic Tracking System |
|---|---|---|
| | If the Device Has This Geofence | 2 Most-Common |
| Leg-type | Stored On-Board, Device Should | Interpretation Upon |
| Geofence | Record This Geofence Violated | Receiving Report of that |
| Name | When It Determines It Has . . . | Geofence's Violation |
| 11 | Exited the specified 11 radius | Leg 1 Pickup |
| 12 | Entered the specified 12 radius | Leg 1 Delivery |
| 21 | Exited the specified 21 radius | Leg 2 Pickup |
| 22 | Entered the specified 22 radius | Leg 2 Delivery |
| 31 | Exited the specified 31 radius | Leg 3 Pickup |
| 32 | Entered the specified 32 radius | Leg 3 Delivery |
| 41 | Exited the specified 41 radius | Leg 4 Pickup |
| 42 | Entered the specified 42 radius | Leg 4 Delivery |
| 51 | Exited the specified 51 radius | Leg 5 Pickup |
| 52 | Entered the specified 52 radius | Leg 5 Delivery |
| 61 | Exited the specified 61 radius | Leg 6 Pickup |
| 62 | Entered the specified 62 radius | Leg 6 Delivery |

Table 2 below includes example Geofence names and activities for airport-type Geofences.

TABLE 2
Geofence Name and Activity for Airports

| | If the Device Has This | | |
|---|---|---|---|
| | Geofence Stored On- | | Electronic Tracking |
| | Board, Device Should | After Recording | System 2 Most-Common |
| Airport-type | Record This Geofence | This Geofence | Interpretation Upon |
| Geofence | Violated When It | Violated, the Data | Receiving Report of that |
| Name | Determines It Has . . . | Logger Should . . . | Geofence's Violation |
| YQX_ENTRY | Entered the specified | Activate Aircraft | Data Logger just discovered |
| | YQX_ENTRY radius | Mode if it is not | it was within Gander |
| | | already enabled | International Airport Radius - |
| | | | and activated Aircraft |
| | | | Mode if it was not already |
| | | | activated |
| YQX_EXIT | Exited the specified | Deactivate Aircraft | Data Logger just discovered |
| | YQX_EXIT radius | Mode as long as | it was exterior to Gander |
| | | there is no other | International Airport Radius - |
| | | indication it is | and might have |
| | | currently on an | deactivated Aircraft Mode if |
| | | airplane flight | there is no other reason to |
| | | | keep it active |
| YTZ_ENTRY | Entered the specified | Activate Aircraft | Data Logger just discovered |
| | YTZ_ENTRY radius | Mode if it is not | it was within Billy Bishop |
| | | already enabled | Toronto City Airport Radius - |
| | | | and activated Aircraft |
| | | | Mode if it was not already |
| | | | activated |
| YTZ_EXIT | Exited the specified | Deactivate Aircraft | Data Logger just discovered |
| | YTZ_EXIT radius | Mode as long as | it was exterior to Billy |
| | | there is no other | Bishop Toronto City |
| | | indication it is | Airport Radius - and might |
| | | currently on an | have deactivated Aircraft |
| | | airplane flight | Mode if there is no other |
| | | | reason to keep it active |

Multiple on-board Geofences may have the same latitude and longitude. Two geofences with the same latitude and longitude may have the same radius value or different radius values. A radius value can be a positive integer value of meters. The radius value of a Leg-type Geofence with activity “entry” can be equal to or less than 300 meters. The radius value of a Leg-type Geofence with activity “exit” can be equal to or less than 1600 meters. The radii for “entry” and “exit” activities for an Airport-type Geofence can be the same radii value.

A Geofence with an activity “entry” can be considered violated if the last known location of the data logger 10 was outside the radius of that Geofence and now the system detects the data logger 10 is inside the radius of that Geofence. A Geofence with an activity “exit” can be considered violated if the last known location of the data logger 10 was inside the radius of that Geofence and now the system detects the data logger 10 is outside the radius of that Geofence. Various Geofences can be saved in memory 14. In various embodiments, the Geofences can be received by the data logger 10 from the remote monitoring unit 4.

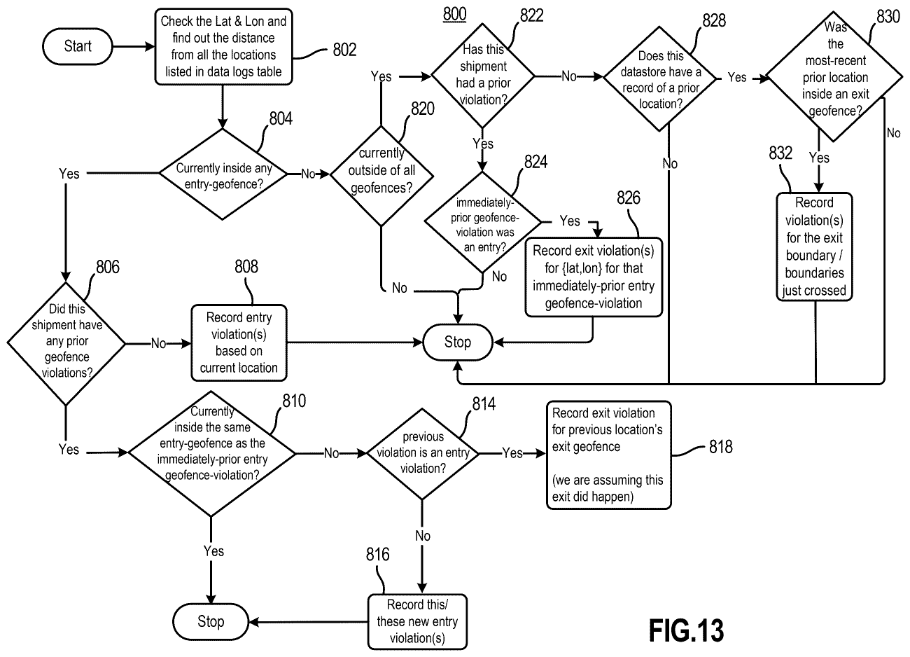

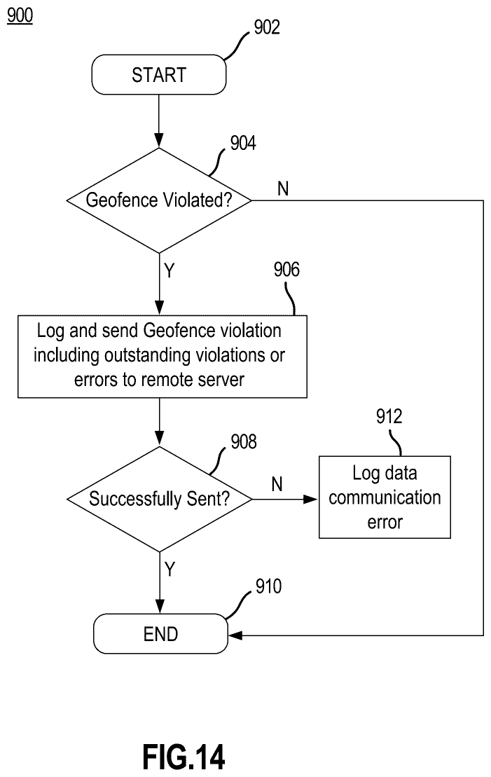

With continued reference to FIG. 1 and FIG. 2, one may appreciate that the data logger 10 thus may have logical aspects that perform different logical steps. While these logical aspects are shown separately throughout the figures (i.e., FIG. 2, FIG. 13, FIG. 14), one may appreciate that the logical aspects may be combined or differently arranged. The data logger 10 can gather and/or determine Geofence boundaries (block 202). For example, the data logger 10 can fetch Geofence boundaries saved to memory 14. The data logger 10 can further determine a present location of the sensorized shipping container 8 (block 204). For example, the controller 12 can receive sensor readings from a sensor 18, such as a GPS sensor, and determine the location of the sensorized shipping container 8 based on the assumption that the sensor 18 is located in and/or on the sensorized shipping container 8. In this manner, the data logger 10 can compare location data of the shipping container 8 with Geofence boundaries to determine whether a Geofence activity has been violated. The data logger 10 can determine whether the last known location of the data logger 10 was outside the radius of the Geofence and the present location of the data logger 10 is inside the Geofence (block 206). In response to the data logger 10 determining that the answer at block 206 is “yes,” the data logger 10 can determine that the Geofence “entry” activity is violated (block 208). Similarly, the data logger 10 can determine whether the last known location of the data logger 10 was inside the radius of the Geofence and the present location of the data logger 10 is outside the Geofence (block 210). In response to the data logger 10 determining that the answer at block 210 is “yes,” the data logger 10 can determine that the Geofence “exit” activity is violated (block 212). The method 200 can be repeated to continuously monitor the location of the shipping container 8. Moreover, while illustrated as a continuously repeating method for convenience, one appreciate that the method may operate with periodic polling and sleep intervals, with interrupt-driven sensing principles, or other mechanisms and various blocks may occur simultaneously, or in differing order, or with interstitial pauses or interrupts.

At any one of blocks 202, 204, 206, 208, 210, and/or 212 of method 200, the data logger 10 can further transmit the location data and/or Geofence violated activities to the remote monitoring unit 4 to provide an updated location and/or condition of the shipping container 8 and/or Dewar 30. For instance, the remote monitoring unit 4 may query the controller 12 of the data logger 10 to return data corresponding to the location of the shipping container 8. In further instances, the controller 12 of the data logger 10 may transmit the location data (e.g., at predetermined intervals and/or in response to predetermined events) to the remote monitoring unit 4 rather than responding to a query.

When the data logger 10 detects its location has changed, if the location change violates more than one onboard-stored Geofence, then the data logger 10 can record into its onboard data store (e.g., memory 14) each and every Geofence that was violated by that location change. After the data logger 10 records violated Geofence activities, the data logger 10 can attempt to report them to the remote monitoring unit 4. If an attempt to report the Geofence violation is unsuccessful (e.g., due to a network issue), the data logger 10 can re-attempt to transmit any still-unsent event records either after a certain duration of time has expired and/or at the next time a Geofence violation has been detected, or in response to a request received from the remote monitoring unit 4.

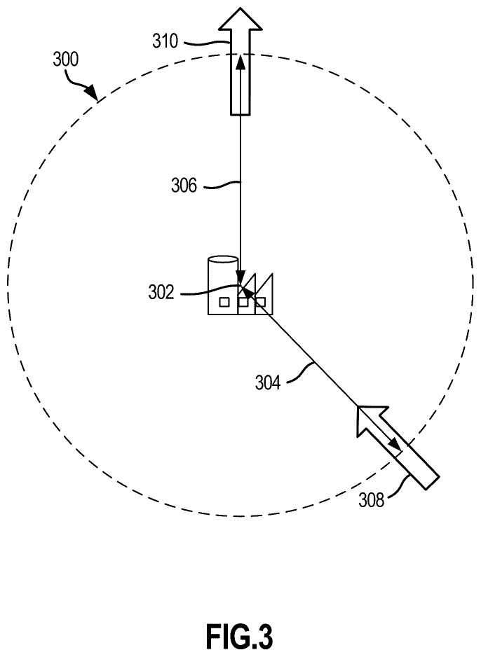

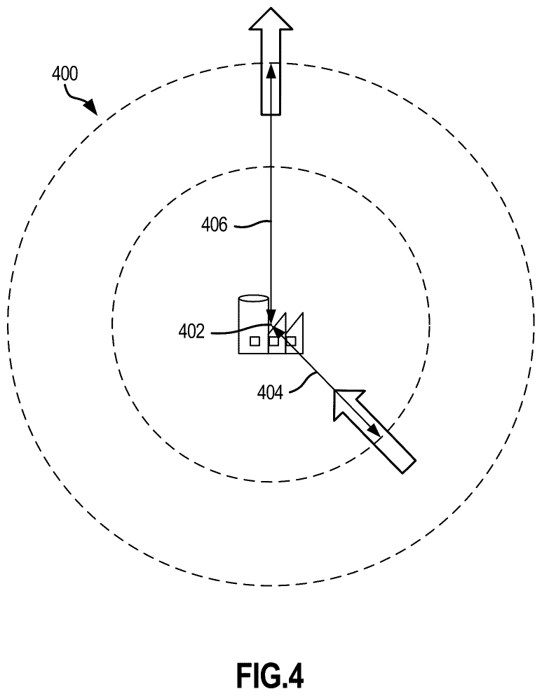

FIG. 3 is an illustration of a Geofence 300, in accordance with various embodiments. The Geofence 300 can be defined by a location 302 (e.g., latitude and longitude) and a radius 304. In the illustrated embodiment, the Geofence 300 has the same entry radius 304 and exit radius 306. Stated differently, an entry activity of the Geofence 300 can be defined by the entry radius 304 and an exit activity of the Geofence 300 can be defined by the exit radius 306. As a shipping container travels along a first leg or route (depicted by arrow 308) from a start position to the location 302, the entry activity can be violated when the shipping container travels from outside the entry radius 304 of the Geofence 300 to inside the entry radius 304 of the Geofence 300. The shipping container can be processed (e.g., loaded onto a truck, plane, boat, etc., filled with a product, and/or emptied of a product, etc.) at the location 302 and then continue onto a subsequent leg or route (depicted by arrow 310) from the location 302 to a subsequent destination. As a shipping container travels away from the location 302, the exit activity can be violated when the shipping container travels from inside the exit radius 306 of the Geofence 300 to outside the exit radius 306 of the Geofence 300. In various embodiments, the entry radius and the exit radius can be symmetric, for example as illustrated in FIG. 3. In various embodiments, the entry radius and the exit radius can be asymmetric, for example as illustrated in FIG. 4.

FIG. 4 is an illustration of a Geofence 400 having an entry radius 404 that is smaller than an exit radius 406, in accordance with various embodiments. In this manner, entry and exit activities are defined at two different distances from the location 402.

In various embodiments, and with reference to FIG. 1, the data logger 10 can be configured to determine that a route's start and finish radii overlap and proportionally shrink the start and finish radii until not only they do not overlap, but also have some separation (e.g., at least 10 meters) between their closest points. The remote monitoring unit 4 can receive the proportionally shrunk radii when the data logger 10 transmits the Geofence data to the remote monitoring unit 4.

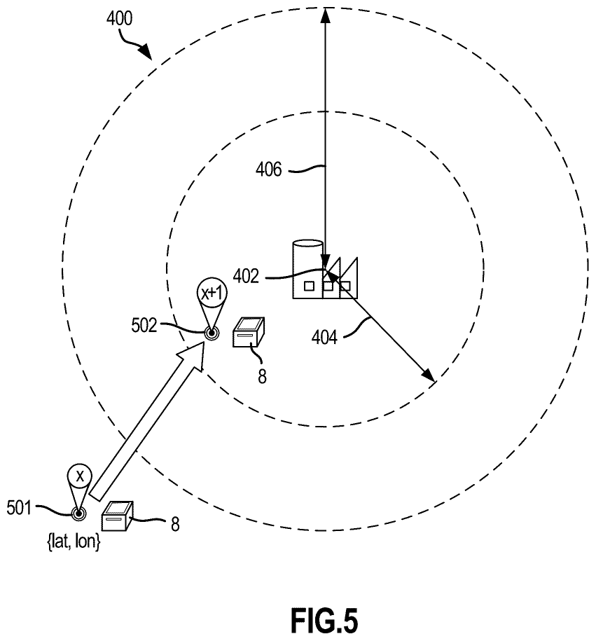

With reference to FIG. 5, an example representation of a data logger determining a violation of an entry activity for a leg-type Geofence is illustrated, in accordance with various embodiments. With respect to FIG. 5, elements with like element numbering, as depicted in FIG. 4, are intended to be the same and will not necessarily be repeated for the sake of clarity. A last known location 501 of the shipping container 8 can be outside the entry radius 404. In the illustrated embodiment, the last known location 501 is also outside the exit radius 406, though this has no effect on the entry violation determination. A present location 502 of the shipping container 8 can be inside the entry radius 404. The present location 502 is also inside the exit radius 406, though this has no effect on the entry activity violation determination. As a result of the present location 502 being inside the entry radius 404 and the last known location 501 being outside the entry radius 404, the data logger 10 can determine a violation of the entry activity of Geofence 400.

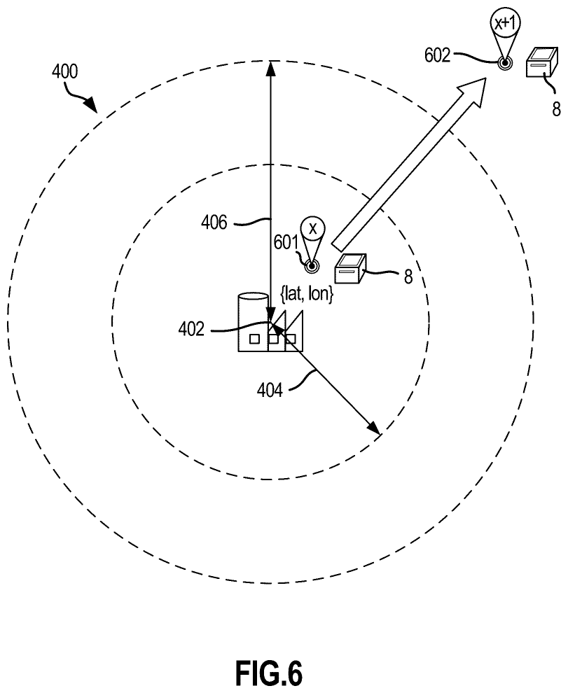

With reference to FIG. 6, an example representation of a data logger determining a violation of an exit activity for a leg-type Geofence is illustrated, in accordance with various embodiments. With respect to FIG. 6, elements with like element numbering, as depicted in FIG. 4, are intended to be the same and will not necessarily be repeated for the sake of clarity. A last known location 601 of the shipping container 8 can be inside the exit radius 406. In the illustrated embodiment, the last known location 601 is also inside the entry radius 404, though this has no effect on the exit activity violation determination. A present location 602 of the shipping container 8 can be outside the exit radius 406. The present location 602 is also outside the entry radius 404, though this has no effect on the entry violation determination. As a result of the present location 602 being outside the exit radius 406 and the last known location 601 being inside the exit radius 406, the data logger 10 can determine a violation of the exit activity of Geofence 400.

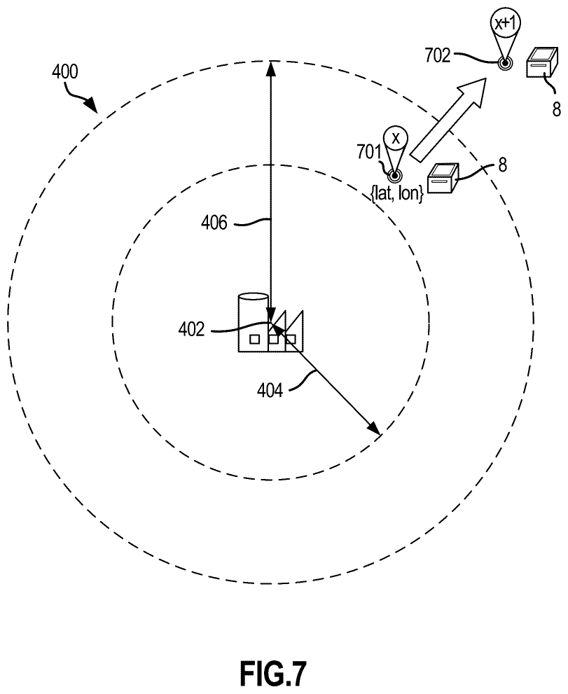

With reference to FIG. 7, an example representation of a data logger determining a violation of an exit activity for a leg-type Geofence is illustrated, in accordance with various embodiments. With respect to FIG. 7, elements with like element numbering, as depicted in FIG. 4, are intended to be the same and will not necessarily be repeated for the sake of clarity. In FIG. 7, a last known location 701 of the shipping container 8 can be inside the exit radius 406, but outside the entry radius 404. As a result of the present location 702 being outside the exit radius 406 and the last known location 701 being inside the exit radius 406, the data logger 10 can determine a violation of the exit activity of Geofence 400. When there is poor GPS signal within the entry radius 404, the entry activity of the Geofence 400 may go undetected as “violated.” For this reason, the remote monitoring unit 4 can have a built-in functionality to declare an “implied delivery” on the immediately prior leg if it receives a “leg start” notification from the data logger 10 and did not receive the expected delivery notification from the data logger 10 for the prior leg.

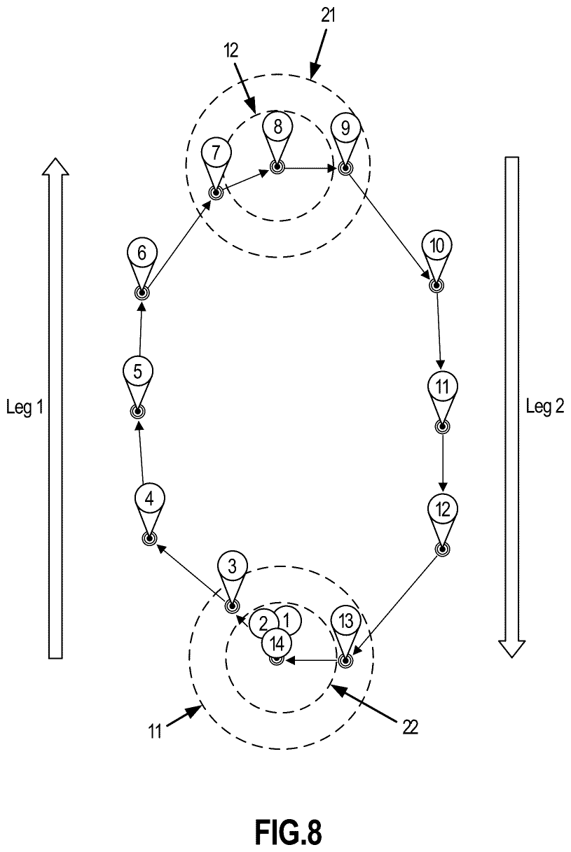

With reference to FIG. 8, an example representation of a two-leg shipment with the same start and finish sites is schematically illustrated, in accordance with various embodiments. For example, a manufacturer of a material can stage all of the equipment necessary to process a shipment at their facility so that-when a commodity comes off the manufacturing line—it can be immediately placed inside the insulated container (e.g., Dewar 30) of the shipping container and handed to a courier. In various embodiments, when the shipping container arrives at its destination, the recipient can retrieve the commodity from the insulated chamber. The empty shipping container can then be transferred to a courier to start its return leg. The diagram of FIG. 8 represents an example order scenario—where the staging facility is permitted to accept back the empty shipper- and thus in an attempt to keep a “closed” inventory system, the empty shipping container is returned to its initial start point (the manufacturer's staging facility), where the reusable shipping container items can be cleaned, reconditioned/recharged, and used for another shipment. For example, the order destination can be a vaccine site, a health care facility, or any other site where temperature-sensitive materials are used and/or stored.

Table 3 below is an example Geofence list sent to a data logger for the example two-leg shipment of FIG. 8. While not included in this table for sake of brevity, the list can also include the radius of the Geofence.

TABLE 3
Example Geofence list sent to the Data Logger

| Geofence | | | |
|---|---|---|---|
| Name | Location | Activity | Type |
| 11 | Manufacturing Site | Exit | Leg |
| 12 | Order Destination | Entry | Leg |
| 21 | Order Destination | Exit | Leg |
| 22 | Manufacturing Site | Entry | Leg |

Table 4 below includes example explanations of the locations represented in FIG. 8.

TABLE 4
Explanations of the Locations Represented in FIG. 8

| Location # | FIG. 8 Explanation |
|---|---|
| 1 | During processing of the order, a person at the processing station pushes the |
| | button on the Data Logger to force it to determine its current location. |
| | This is to make sure that the Data Logger knows it is inside the Manufacturing |
| | Site's Exit Radius so that - when it detects it is beyond that Exit Radius, it will |
| | know it has crossed that Geofence. |
| | Data Logger Events: |
| | IF this pushing of the button happens while the Data Logger's onboard |
| | Geofence list contains an Entry Geofence for the Data Logger's Return Leg |
| | AND IF that Entry Geofence {lat, lon} happens to be the Manufacturing Site |
| | AND IF the Data Logger's last detected location happened to be outside that |
| | Entry Geofence |
| | THEN the Data Logger will record and report a violation for that Entry |
| | Geofence. In the case of the Geofence list above, that would be a “22” |
| | Geofence Violation. |
| 2 | The Data Logger happens to take a location reading that happens to still be |
| | inside the Manufacturing Site's Exit Radius - and happens to also be inside |
| | the co-located Entry Radius for the Manufacturing Site. |
| | Data Logger Events: |
| | None - because no Geofences have been violated. The “22” Entry Geofence |
| | violation would have been detected at Location #1. |
| 3 | The Data Logger happens take a location reading that happens to still be inside |
| | the Manufacturing Site's Exit Radius - and happens to also be outside the |
| | Manufacturing Site's Entry Radius. |
| | Data Logger Events: |
| | None - because no Geofences have been violated. Going beyond the “22” |
| | Entry Geofence means nothing. |
| 4 | The Data Logger happens to take a location reading that is - for the first time |
| | on this shipment - outside the Manufacturing Site's Geofence Exit Radius. |
| | The last recorded location prior to this was inside the Manufacturing Site's |
| | Geofence Exit Radius |
| | Data Logger Events: |
| | The Data Logger records and reports a “11” Exit Geofence violation. |
| 5 | The Data Logger happens to take a location reading that is outside of all |
| | Geofence radii. |
| | Data Logger Events: |
| | None - because no Geofences have been violated. The “11” Exit Geofence |
| | violation would have been detected at Location #4. |
| 6 | The Data Logger happens to take a location reading that is outside of all |
| | Geofence radii. |
| | Data Logger Events: |
| | None - because no Geofences have been violated. The “11” Exit Geofence |
| | violation would have been detected at Location #4. |
| 7 | The Data Logger happens to take a location reading that is inside the Exit |
| | Geofence radius for the Destination Site - but has not yet crossed the Entry |
| | Geofence radius for the Destination Site. |
| | Data Logger Events: |
| | None - because no Geofences have been violated. |
| 8 | The Data Logger happens to take a location reading that is - for the first time |
| | on this shipment - inside the Destination Site's Geofence Entry Radius. The |
| | last recorded location prior to this was outside the Destination Site's Geofence |
| | Entry Radius. |
| | Data Logger Events: |
| | The Data Logger records and reports a “12” Entry Geofence violation. |
| 9 | The Data Logger happens take a location reading that happens to still be inside |
| | the Destination Site's Exit Radius - and happens to also be outside the |
| | Destination Site's Entry Radius. |
| | Data Logger Events: |
| | None - because no Geofences have been violated. Going beyond the “12” |
| | Entry Geofence means nothing. |
| 10 | The Data Logger happens to take a location reading that is - for the first time |
| | on this shipment - crosses from inside to outside the Destination Site's |
| | Geofence Exit Radius. |
| | Data Logger Events: |
| | The Data Logger records and reports a “21” Exit Geofence violation. |
| 11 | The Data Logger happens to take a location reading that is outside of all |
| | Geofence radii. |
| | Data Logger Events: |
| | None - because no Geofences have been violated. The “21” Exit Geofence |
| | violation would have been detected at Location #10. |
| 12 | The Data Logger happens to take a location reading that is outside of all |
| | Geofence radii. |
| | Data Logger Events: |
| | None - because no Geofences have been violated. The “21” Exit Geofence |
| | violation would have been detected at Location #10. |
| 13 | The Data Logger happens to take a location reading that is inside the Exit |
| | Geofence radius for the Manufacturing Site - but has not yet crossed the Entry |
| | Geofence radius for the Manufacturing Site. |
| | Data Logger Events: |
| | None - because no Geofences have been violated. |
| 14 | The Data Logger happens to take a location reading that is inside the |
| | Manufacturing Site's Geofence Entry Radius. The last recorded location prior |
| | to this was outside the Manufacturing Site's Geofence Entry Radius. |
| | Data Logger Events: |
| | The Data Logger records and reports a “22” Entry Geofence violation. |

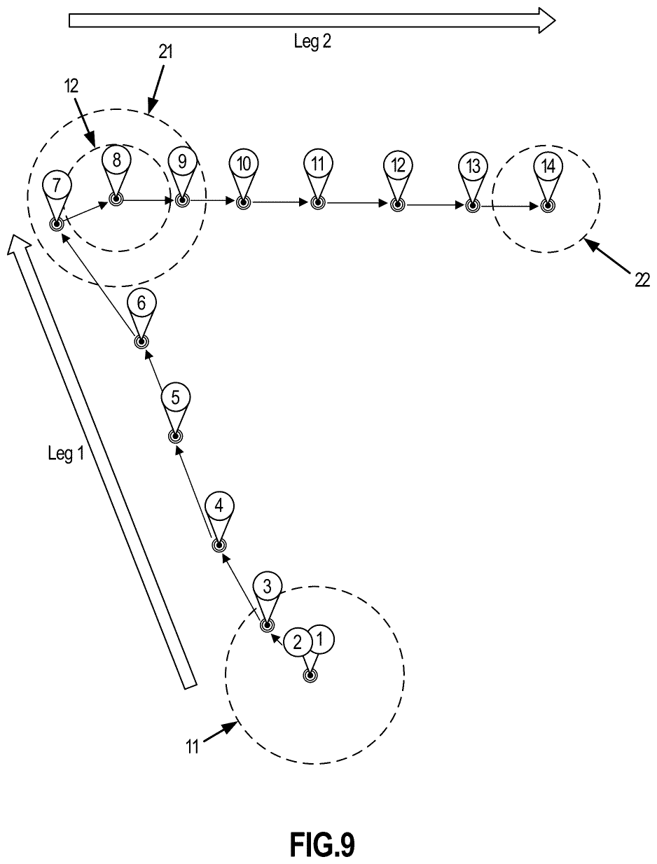

With reference to FIG. 9, an example representation of a two-leg shipment with different start and finish sites is schematically illustrated, in accordance with various embodiments. In various embodiments, the staging/manufacturer facility may not accept back empty shipping containers. The empty shipping container may not be returned to its initial start point, but to a different facility (e.g., a logistics center) where the shipping container's reusable parts can be cleaned, recharged, and/or reconditioned for another shipment. At some point, the shipping containers can be transferred (e.g., in bulk) to the staging/manufacturer facility.

Table 5 below is an example Geofence list sent to a data logger for the example two-leg shipment of FIG. 9. While not included in this table for sake of brevity, the list can also include the radius of the Geofence.

TABLE 5
Example Geofence list sent to the Data Logger

| Geofence | | | |
|---|---|---|---|
| Name | Location | Activity | Type |
| 11 | Manufacturing Site | Exit | Leg |
| 12 | Order Destination | Entry | Leg |
| 21 | Order Destination | Exit | Leg |
| 22 | Logistics Site | Entry | Leg |

Table 6 below includes example explanations of the locations represented in FIG. 9.

TABLE 6
Explanations of the Locations Represented in FIG. 9

| Location # | FIG. 9 Explanation |
|---|---|
| 1 | During processing of the order, a person at the processing station pushes the |
| | button on the Data Logger to force it to determine its current location. |
| | This is to make sure that the Data Logger knows it is inside the |
| | Manufacturing Site's Exit Radius so that - when it detects it is beyond that |
| | Exit Radius, it will know it has crossed that Geofence. |
| | Data Logger Events: |
| | None - because no Geofences have been violated as of yet. |
| 2 | The Data Logger happens take a location reading that happens to still be |
| | inside the Manufacturing Site's Exit Radius. |
| | Data Logger Events: |
| | None - because no Geofences have been violated as of yet. |
| 3 | The Data Logger happens take a location reading that happens to still be |
| | inside the Manufacturing Site's Exit Radius. |
| | Data Logger Events: |
| | None - because no Geofences have been violated as of yet. |
| 4 | The Data Logger happens to take a location reading that is - for the first time |
| | on this shipment - outside the Manufacturing Site's Geofence Exit Radius. |
| | The last recorded location prior to this was inside the Manufacturing Site's |
| | Geofence Exit Radius |
| | Data Logger Events: |
| | The Data Logger records and reports a “11” Exit Geofence violation. |
| 5 | The Data Logger happens to take a location reading that is outside of all |
| | Geofence radii. |
| | Data Logger Events: |
| | None - because no Geofences have been violated. The “11” Exit Geofence |
| | violation would have been detected at Location #4. |
| 6 | The Data Logger happens to take a location reading that is outside of all |
| | Geofence radii. |
| | Data Logger Events: |
| | None - because no Geofences have been violated. The “11” Exit Geofence |
| | violation would have been detected at Location #4. |
| 7 | The Data Logger happens to take a location reading that is inside the Exit |
| | Geofence radius for the Destination Site - but has not yet crossed the Entry |
| | Geofence radius for the Destination Site. |
| | Data Logger Events: |
| | None - because no Geofences have been violated. |
| 8 | The Data Logger happens to take a location reading that is - for the first time |
| | on this shipment - inside the Destination Site's Geofence Entry Radius. The |
| | last recorded location prior to this was outside the Destination Site's |
| | Geofence Entry Radius |
| | Data Logger Events: |
| | The Data Logger records and reports a “12” Entry Geofence violation. |
| 9 | The Data Logger happens take a location reading that happens to still be |
| | inside the Destination Site's Exit Radius - and happens to also be outside the |
| | Destination Site's Entry Radius. |
| | Data Logger Events: |
| | None - because no Geofences have been violated. Going beyond the “12” |
| | Entry Geofence means nothing. |
| 10 | The Data Logger happens to take a location reading that is - for the first time |
| | on this shipment - crosses from inside to outside the Destination Site's |
| | Geofence Exit Radius. |
| | Data Logger Events: |
| | The Data Logger records and reports a “21” Exit Geofence violation. |
| 11 | The Data Logger happens to take a location reading that is outside of all |
| | Geofence radii. |
| | Data Logger Events: |
| | None - because no Geofences have been violated. The “21” Exit Geofence |
| | violation would have been detected at Location #10. |
| 12 | The Data Logger happens to take a location reading that is outside of all |
| | Geofence radii. |
| | Data Logger Events: |
| | None - because no Geofences have been violated. The “21” Exit Geofence |
| | violation would have been detected at Location #10. |
| 13 | The Data Logger happens to take a location reading that is outside of all |
| | Geofence radii. |
| | Data Logger Events: |
| | None - because no Geofences have been violated. The “21” Exit Geofence |
| | violation would have been detected at Location #10. |
| 14 | The Data Logger happens to take a location reading that is - for the first time |
| | on this shipment - inside the Logistics Center's Geofence Entry Radius. The |
| | last recorded location prior to this was outside the Logistics Center's |
| | Geofence Entry Radius |
| | Data Logger Events: |
| | The Data Logger records and reports a “22” Entry Geofence violation. |

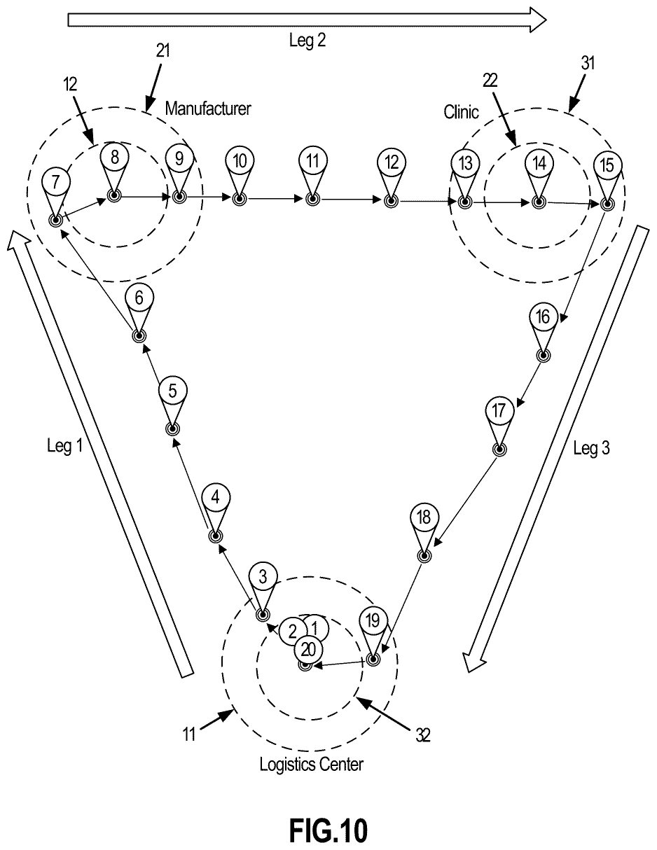

With reference to FIG. 10, an example representation of a three-leg shipment with the same start and finish sites is schematically illustrated, in accordance with various embodiments. Table 7 below is an example Geofence list sent to a data logger for the example three-leg shipment of FIG. 10. While not included in this table for sake of brevity, the list can also include the radius of the Geofence.

TABLE 7
Example Geofence list sent to the Data Logger

| Geofence | | | |
|---|---|---|---|
| Name | Location | Activity | Type |
| 11 | Logistics Center | Exit | Leg |
| 12 | Customer Origin | Entry | Leg |
| 21 | Customer Origin | Exit | Leg |
| 22 | Customer Destination | Entry | Leg |
| 31 | Customer Destination | Exit | Leg |
| 32 | Logistics Center | Entry | Leg |

Table 8 below includes example explanations of the locations represented in FIG. 10.

TABLE 8
Explanations of the Locations Represented in FIG. 10

| Location # | FIG. 10 Explanation |
|---|---|
| 1 | During processing of the order, a person at the processing station pushes the |
| | button on the Data Logger to force it to determine its current location. |
| | This is to make sure that the Data Logger knows it is inside the Manufacturing |
| | Site's Exit Radius so that - when it detects it is beyond that Exit Radius, it will |
| | know it has crossed that Geofence. |
| | Data Logger Events: |
| | IF this pushing of the button happens while the Data Logger's onboard |
| | Geofence list contains an Entry Geofence for the Data Logger's Return Leg |
| | AND IF that Entry Geofence {lat, lon} happens to be the Logistics Center |
| | AND IF the Data Logger's last detected location happened to be outside that |
| | Entry Geofence |
| | THEN the Data Logger will record and report a violation for that Entry |
| | Geofence. In the case of the Geofence list above, that would be a “32” |
| | Geofence Violation. |
| 2 | The Data Logger happens to take a location reading that happens to still be |
| | inside the Logistics Center's Exit Radius - and happens to also be inside the |
| | collocated Entry Radius for the Logistics Center. |
| | Data Logger Events: |
| | None - because no Geofences have been violated. The “32” Entry Geofence |
| | violation would have been detected at Location #1. |
| 3 | The Data Logger happens take a location reading that happens to still be inside |
| | the Manufacturing Site's Exit Radius. |
| | Data Logger Events: |
| | None - because no Geofences have been violated. Going beyond the “32” |
| | Entry Geofence means nothing. |
| 4 | The Data Logger happens to take a location reading that is - for the first time |
| | on this shipment - outside the Logistics Center's Geofence Exit Radius. The |
| | last recorded location prior to this was inside the Logistics Center's Geofence |
| | Exit Radius |
| | Data Logger Events: |
| | The Data Logger records and reports a “11” Exit Geofence violation. |
| 5 | The Data Logger happens to take a location reading that is outside of all |
| | Geofence radii. |
| | Data Logger Events: |
| | None - because no Geofences have been violated. The “11” Exit Geofence |
| | violation would have been detected at Location #4. |
| 6 | The Data Logger happens to take a location reading that is outside of all |
| | Geofence radii. |
| | Data Logger Events: |
| | None - because no Geofences have been violated. The “11” Exit Geofence |
| | violation would have been detected at Location #4. |
| 7 | The Data Logger happens to take a location reading that is inside the Exit |
| | Geofence radius for the Customer Origin Site - but has not yet crossed the |
| | Entry Geofence radius for the Customer Origin Site. |
| | Data Logger Events: |
| | None - because no Geofences have been violated. |
| 8 | The Data Logger happens to take a location reading that is - for the first time |
| | on this shipment - inside the Customer Origin's Geofence Entry Radius. The |
| | last recorded location prior to this was outside the Customer Origin's Geofence |
| | Entry Radius. |
| | Data Logger Events: |
| | The Data Logger records and reports a “12” Entry Geofence violation. |
| 9 | The Data Logger happens take a location reading that happens to still be inside |
| | the Customer Origin's Exit Radius - and happens to also be outside the |
| | Customer Origin's Entry Radius. |
| | Data Logger Events: |
| | None - because no Geofences have been violated. Going beyond the “12” |
| | Entry Geofence means nothing. |
| 10 | The Data Logger happens to take a location reading that is - for the first time |
| | on this shipment - crosses from inside to outside the Customer Origin's |
| | Geofence Exit Radius. |
| | Data Logger Events: |
| | The Data Logger records and reports a “21” Exit Geofence violation. |
| 11 | The Data Logger happens to take a location reading that is outside of all |
| | Geofence radii. |
| | Data Logger Events: |
| | None - because no Geofences have been violated. The “21” Exit Geofence |
| | violation would have been detected at Location #10. |
| 12 | The Data Logger happens to take a location reading that is outside of all |
| | Geofence radii. |
| | Data Logger Events: |
| | None - because no Geofences have been violated. The “21” Exit Geofence |
| | violation would have been detected at Location #10. |
| 13 | The Data Logger happens to take a location reading that is inside the Exit |
| | Geofence radius for the Customer Destination Site - but has not yet crossed |
| | the Entry Geofence radius for the Customer Destination Site. |
| | Data Logger Events: |
| | None - because no Geofences have been violated. |
| 14 | The Data Logger happens to take a location reading that is - for the first time |
| | on this shipment - inside the Customer Destination Site's Geofence Entry |
| | Radius. The last recorded location prior to this was outside the Customer |
| | Destination Site's Geofence Entry Radius. |
| | Data Logger Events: |
| | The Data Logger records and reports a “22” Entry Geofence violation. |
| 15 | The Data Logger happens take a location reading that happens to still be inside |
| | the Customer Destination Site's Exit Radius - and happens to also be outside |
| | the Customer Destination Site's Entry Radius. |
| | Data Logger Events: |
| | None - because no Geofences have been violated. Going beyond the “22” |
| | Entry Geofence means nothing. |
| 16 | The Data Logger happens to take a location reading that is - for the first time |
| | on this shipment - crosses from inside to outside the Customer Destination |
| | Site's Geofence Exit Radius. |
| | Data Logger Events: |
| | The Data Logger records and reports a “31” Exit Geofence violation. |
| 17 | The Data Logger happens to take a location reading that is outside of all |
| | Geofence radii. |
| | Data Logger Events: |
| | None - because no Geofences have been violated. The “31” Exit Geofence |
| | violation would have been detected at Location #16. |
| 18 | The Data Logger happens to take a location reading that is outside of all |
| | Geofence radii. |
| | Data Logger Events: |
| | None - because no Geofences have been violated. The “31” Exit Geofence |
| | violation would have been detected at Location #16. |
| 19 | The Data Logger happens to take a location reading that is inside the Exit |
| | Geofence radius for the Logistics Center - but has not yet crossed the Entry |
| | Geofence radius for the Logistics Center. |
| | Data Logger Events: |
| | None - because no Geofences have been violated. |
| 20 | The Data Logger happens to take a location reading that is inside the |
| | Logistics Center's Geofence Entry Radius. The last recorded location prior to |
| | this was outside the Logistics Center's Geofence Entry Radius |
| | Data Logger Events: |
| | The Data Logger records and reports a “32” Entry Geofence violation. |

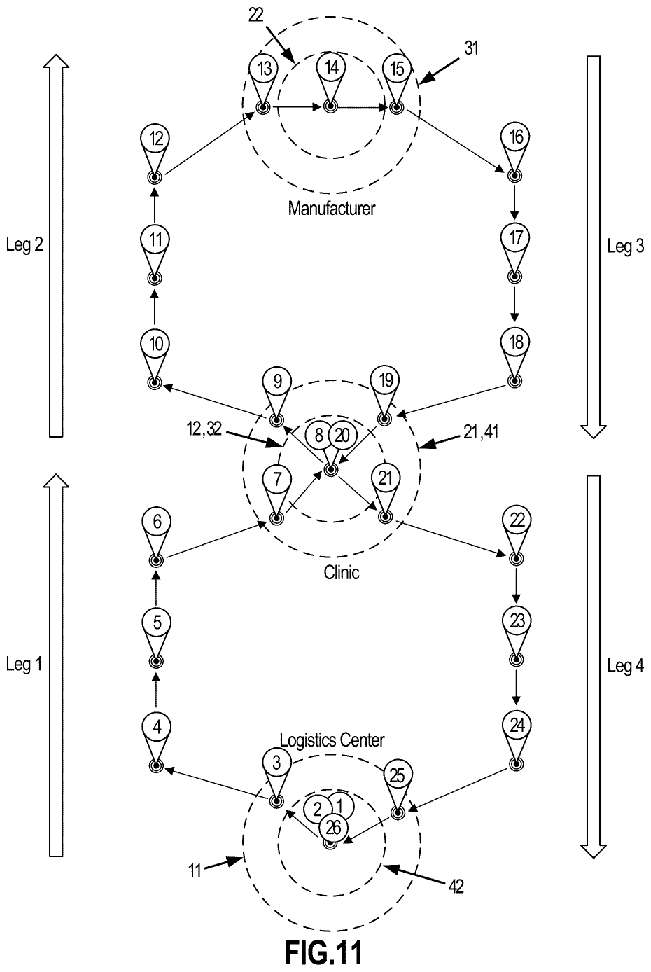

With reference to FIG. 11, an example representation of a four-leg shipment with the same start and finish sites is schematically illustrated, in accordance with various embodiments. For example, a manufacturer can ship to a clinic when a manufacturer of a treatment/cure for a patient will be altering the patient's own cells to fight whatever is ailing them. Because it is the patient's own cells, the risk of rejection of the treatment/cure is effectively zero. A logistics center can ship an empty shipping container to a clinic. The clinic can withdraw the patient's own cells and place the sample inside the insulated container. The clinic can ship the shipping container to the manufacturer with the commodity inside the insulated container. The manufacturer can alter the patient's own cells and put the altered cells back into the insulated container. The manufacturer can send the shipment back to the clinic with the altered cells in the insulated container. The clinic can then remove the altered cells and treat the patient with the altered cells. The clinic can send the empty shipping container back to the logistics center.

Table 9 below is an example Geofence list sent to a data logger for the example four-leg shipment of FIG. 11. While not included in this table for sake of brevity, the list can also include the radius of the Geofence.

TABLE 9
Example Geofence list sent to the Data Logger

| Geofence | | | |
|---|---|---|---|
| Name | Location | Activity | Type |
| 11 | Logistics Center | Exit | Leg |
| 12 | Clinic | Entry | Leg |
| 21 | Clinic | Exit | Leg |
| 22 | Manufacturer | Entry | Leg |
| 31 | Manufacturer | Exit | Leg |
| 32 | Clinic | Entry | Leg |
| 41 | Clinic | Exit | Leg |
| 42 | Logistics Center | Entry | Leg |

The result of the Geofence list of Table 9 and the example shipment depicted in FIG. 11 results in the following concurrent Geofence violation report of Table 10. The data logger can record and report detected concurrent Geofence violations. It can be up to the consumer of those Geofence Violations to determine what action(s) to take or not take.

TABLE 10
Example Geofence Violations Report

| Location | Activity | Geofence Violation(s) |
|---|---|---|
| Logistics Center | Exit | 11 |
| Logistics Center | Entry | 42 |
| Clinic | Exit | Concurrently 21 & 41 |
| Clinic | Entry | Concurrently 12 & 32 |
| Manufacturer | Exit | 31 |
| Manufacturer | Entry | 22 |

Table 11 below includes example explanations of the locations represented in FIG. 11.

TABLE 11
Explanations of the Locations Represented in FIG. 11

| Location # | FIG. 11 Explanation |
|---|---|
| 1 | During processing of the order, a person at the processing station pushes the |
| | button on the Data Logger to force it to determine its current location. |
| | This is to make sure that the Data Logger knows it is inside the Logistics |
| | Center's Exit Radius so that - when it detects it is beyond that Exit Radius, it |
| | will know it has crossed that Geofence. |
| | Data Logger Events: |
| | IF this pushing of the button happens while the Data Logger's onboard |
| | Geofence list contains an Entry Geofence for the Data Logger's Return Leg |
| | AND IF that Entry Geofence {lat, lon} happens to be the Logistics Center |
| | AND IF the Data Logger's last detected location happened to be outside that |
| | Entry Geofence |
| | THEN the Data Logger will record and report a violation for that Entry |
| | Geofence. In the case of the Geofence list above, that would be a “32” |
| | Geofence Violation. |
| 2 | The Data Logger happens take a location reading that happens to still be |
| | inside the Logistics Center's Exit Radius - and happens to also be inside the |
| | collocated Entry Radius for the Logistics Center. |
| | Data Logger Events: |
| | None - because no Geofences have been violated. The “32” Entry Geofence |
| | violation would have been detected at Location #1. |
| 3 | The Data Logger happens take a location reading that happens to still be |
| | inside the Logistics Center's Exit Radius - and happens to also be outside the |
| | Logistics Center's Entry Radius. |
| | Data Logger Events: |
| | None - because no Geofences have been violated. Going beyond the “32” |
| | Entry Geofence means nothing. |
| 4 | The Data Logger happens to take a location reading that is - for the first time |
| | on this shipment - outside the Logistics Center's Geofence Exit Radius. The |
| | last recorded location prior to this was inside the Logistics Center's Geofence |
| | Exit Radius. |
| | Data Logger Events: |
| | The Data Logger records and reports a “11” Exit Geofence violation. |
| 5 | The Data Logger happens to take a location reading that is outside of all |
| | Geofence radii. |
| | Data Logger Events: |
| | None - because no Geofences have been violated. The “11” Exit Geofence |
| | violation would have been detected at Location #4. |
| 6 | The Data Logger happens to take a location reading that is outside of all |
| | Geofence radii. |
| | Data Logger Events: |
| | None - because no Geofences have been violated. The “11” Exit Geofence |
| | violation would have been detected at Location #4. |
| 7 | The Data Logger happens to take a location reading that is inside the Exit |
| | Geofence radius for the Clinic - but has not yet crossed the Entry Geofence |
| | radius for the Clinic. |
| | Data Logger Events: |
| | None - because no Geofences have been violated. |
| 8 | The Data Logger happens to take a location reading that is - for the first time |
| | on this shipment - inside the Clinic's Geofence Entry Radius. The last |
| | recorded location prior to this was outside the Clinic's Geofence Entry |
| | Radius. |
| | Data Logger Events: |
| | The Data Logger records and reports concurrently a “12” Entry Geofence |
| | violation and a “32” Entry Geofence Violation. |
| 9 | The Data Logger happens take a location reading that happens to still be |
| | inside the Clinic's Exit Radius - and happens to also be outside the Clinic's |
| | Entry Radius. |
| | Data Logger Events: |
| | None - because no Geofences have been violated. Going beyond the “12”/“32” |
| | Entry Geofences means nothing. |
| 10 | The Data Logger happens to take a location reading that is - for the first time |
| | on this shipment - crossing from inside to outside the Clinic's Geofence Exit |
| | Radius. |
| | Data Logger Events: |
| | The Data Logger records and reports concurrently a “21” Exit Geofence |
| | violation and a “41” Exit Geofence Violation. |
| 11 | The Data Logger happens to take a location reading that is outside of all |
| | Geofence radii. |
| | Data Logger Events: |
| | None - because no Geofences have been violated. The “21”/“41” Exit |
| | Geofence violation would have been detected at Location #10. |
| 12 | The Data Logger happens to take a location reading that is outside of all |
| | Geofence radii. |
| | Data Logger Events: |
| | None - because no Geofences have been violated. The “21”/“41” Exit |
| | Geofence violation would have been detected at Location #10. |
| 13 | The Data Logger happens to take a location reading that is inside the Exit |
| | Geofence radius for the Manufacturer Site - but has not yet crossed the Entry |
| | Geofence radius for the Manufacturer. |
| | Data Logger Events: |
| | None - because no Geofences have been violated. |
| 14 | The Data Logger happens to take a location reading that is - for the first time |
| | on this shipment - inside the Manufacturer's Geofence Entry Radius. The last |
| | recorded location prior to this was outside the Manufacturer's Geofence Entry |
| | Radius. |
| | Data Logger Events: |
| | The Data Logger records and reports a “22” Entry Geofence violation. |
| 15 | The Data Logger happens take a location reading that happens to still be |
| | inside the Manufacturer's Exit Radius - and happens to also be outside the |
| | Manufacturer's Entry Radius. |
| | Data Logger Events: |
| | None - because no Geofences have been violated. Going beyond the “22” |
| | Entry Geofence means nothing. |
| 16 | The Data Logger happens to take a location reading that is - for the first time |
| | on this shipment - outside the Manufacturer's Geofence Exit Radius. The last |
| | recorded location prior to this was inside the Manufacturer's Geofence Exit |
| | Radius. |
| | Data Logger Events: |
| | The Data Logger records and reports a “31” Exit Geofence violation. |
| 17 | The Data Logger happens to take a location reading that is outside of all |
| | Geofence radii. |
| | Data Logger Events: |
| | None - because no Geofences have been violated. The “31” Exit Geofence |
| | violation would have been detected at Location #16. |
| 18 | The Data Logger happens to take a location reading that is outside of all |
| | Geofence radii. |
| | Data Logger Events: |
| | None - because no Geofences have been violated. The “31” Exit Geofence |
| | violation would have been detected at Location #16. |
| 19 | The Data Logger happens to take a location reading that is inside the Exit |
| | Geofence radius for the Clinic - but has not yet crossed the Entry Geofence |
| | radius for the Clinic. |
| | Data Logger Events: |
| | None - because no Geofences have been violated. |
| 20 | The Data Logger happens to take a location reading that is inside the Clinic's |
| | Geofence Entry Radius. The last recorded location prior to this was outside |
| | the Clinic's Geofence Entry Radius. |
| | Data Logger Events: |
| | The Data Logger records and reports concurrently a “12” Entry Geofence |
| | violation and a “32” Entry Geofence violation. |
| 21 | The Data Logger happens take a location reading that happens to still be |
| | inside the Clinic's Exit Radius - and happens to also be outside the Clinic's |
| | Entry Radius. |
| | Data Logger Events: |
| | None - because no Geofences have been violated. Going beyond the “12”/“32” |
| | Entry Geofences means nothing. |
| 22 | The Data Logger happens to take a location reading that is - for the second |
| | time on this shipment - crossing from inside to outside the Clinic's Geofence |
| | Exit Radius. |
| | Data Logger Events: |
| | The Data Logger records and reports concurrently a “21” Exit Geofence |
| | violation and a “41” Exit Geofence Violation. |
| 23 | The Data Logger happens to take a location reading that is outside of all |
| | Geofence radii. |
| | Data Logger Events: |
| | None - because no Geofences have been violated. The “21”/“41” Exit |
| | Geofence violation would have been detected at Location #22. |
| 24 | The Data Logger happens to take a location reading that is outside of all |
| | Geofence radii. |
| | Data Logger Events: |
| | None - because no Geofences have been violated. The “21”/“41” Exit |
| | Geofence violation would have been detected at Location #22. |
| 25 | The Data Logger happens to take a location reading that is inside the Exit |
| | Geofence radius for the Logistics Center - but has not yet crossed the Entry |
| | Geofence radius for the Logistics Center. |
| | Data Logger Events: |
| | None - because no Geofences have been violated. |
| 26 | The Data Logger happens to take a location reading that crosses from outside |
| | to inside the Logistics Center's Geofence Entry Radius. |
| | Data Logger Events: |
| | The Data Logger records and reports a “42” Entry Geofence violation. |

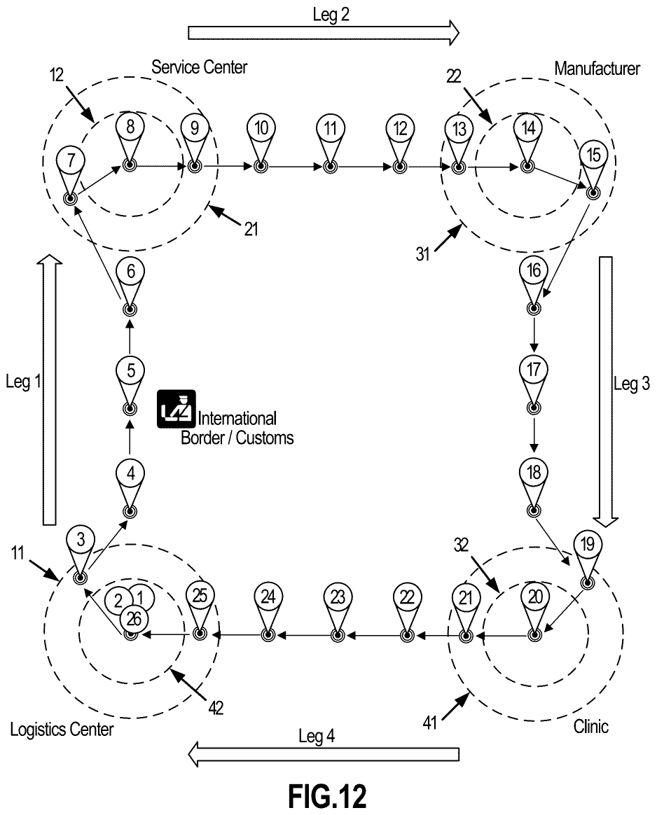

With reference to FIG. 12, an example representation of a four-leg shipment facilitating a service center across an international border is schematically illustrated, in accordance with various embodiments. International border crossings can have customs delays that waste one or more of the limited number of days that a shipping container can maintain its insulated-container temperature, potentially requiring additional tasks to recharge and/or recondition the cooling material inside the insulated container mid-shipment while the commodity is inside the internal chamber. This can be an inherently risky procedure that puts the commodity at risk of spoilage. If there is enough demand from customer origin sites within a country to justify it, a service center can be constructed within that country to facilitate the customer origin sites in that country. In this four-leg shipment, an empty shipping container can be transported from the logistics center, across an international border, to a service center. The shipping container can be sent on this first leg with no cooling. Because there is no cooling, there is no concern about customs delay wasting that cooling. Also, crossing the international border at this stage is easier because the insulated container is empty, so customs clearance tends to be easier. At the service center, the insulated container in the shipping container can be cooled to an appropriate temperature. Moreover, a power source, such as a battery, can be recharged in the accompanying data logger if needed. The still empty shipping container can then be sent to a customer origin site (e.g., a manufacturer). This second leg is a domestic leg so there are not customs delays. The customer origin site can place the commodity inside the insulated container and send the shipping container to a customer destination site (e.g., a clinic). After the customer destination site is finished with the shipping container, the empty shipping container can be returned to the logistics center.

Table 12 below is an example Geofence list sent to a data logger for the example four-leg shipment of FIG. 12. While not included in this table for sake of brevity, the list can also include the radius of the Geofence.

TABLE 12
Example Geofence list sent to the Data Logger

| Geofence | | | |
|---|---|---|---|
| Name | Location | Activity | Type |
| 11 | Logistics Center | Exit | Leg |
| 12 | Service Center | Entry | Leg |
| 21 | Service Center | Exit | Leg |
| 22 | Customer Origin | Entry | Leg |
| 31 | Customer Origin | Exit | Leg |
| 32 | Customer Destination | Entry | Leg |
| 41 | Customer Destination | Exit | Leg |
| 42 | Logistics Center | Entry | Leg |

Table 13 below includes example explanations of the locations represented in FIG. 12.

TABLE 13
Explanations of the Locations Represented in FIG. 12

| Location # | FIG. 12 Explanation |
|---|---|
| 1 | During processing of the order, a person at the processing station pushes the |
| | button on the Data Logger to force it to determine its current location. |
| | This is to make sure that the Data Logger knows it is inside the Logistics |
| | Center's Exit Radius so that - when it detects it is beyond that Exit Radius, it |
| | will know it has crossed that Geofence. |
| | Data Logger Events: |
| | IF this pushing of the button happens while the Data Logger's onboard |
| | Geofence list contains an Entry Geofence for the Data Logger's Return Leg |
| | AND IF that Entry Geofence {lat, lon} happens to be the Logistics Center |
| | AND IF the Data Logger's last detected location happened to be outside that |
| | Entry Geofence |
| | THEN the Data Logger will record and report a violation for that Entry |
| | Geofence. In the case of the Geofence list above, that would be a “42” |
| | Geofence Violation. |
| 2 | The Data Logger happens take a location reading that happens to still be |
| | inside the Logistics Center's Exit Radius - and happens to also be inside the |
| | collocated Entry Radius for the Logistics Center. |
| | Data Logger Events: |
| | None - because no Geofences have been violated. The “42” Entry Geofence |
| | violation would have been detected at Location #1. |
| 3 | The Data Logger happens take a location reading that happens to still be |
| | inside the Logistics Center's Exit Radius - and happens to also be outside the |
| | Logistics Center's Entry Radius. |
| | Data Logger Events: |
| | None - because no Geofences have been violated. Going beyond the “42” |
| | Entry Geofence means nothing. |
| 4 | The Data Logger happens to take a location reading that is - for the first time |
| | on this shipment - outside the Logistics Center's Geofence Exit Radius. The |
| | last recorded location prior to this was inside the Logistics Center's Geofence |
| | Exit Radius |
| | Data Logger Events: |
| | The Data Logger records and reports a “11” Exit Geofence violation. |
| 5 | The Data Logger happens to take a location reading that is outside of all |
| | Geofence radii. |
| | Data Logger Events: |
| | None - because no Geofences have been violated. The “11” Exit Geofence |
| | violation would have been detected at Location #4. |
| 6 | The Data Logger happens to take a location reading that is outside of all |
| | Geofence radii. |
| | Data Logger Events: |
| | None - because no Geofences have been violated. The “11” Exit Geofence |
| | violation would have been detected at Location #4. |
| 7 | The Data Logger happens to take a location reading that is inside the Exit |
| | Geofence radius for the Service Center Site - but has not yet crossed the |
| | Entry Geofence radius for the Service Center Site. |
| | Data Logger Events: |
| | None - because no Geofences have been violated. |
| 8 | The Data Logger happens to take a location reading that is - for the first time |
| | on this shipment - inside the Service Center Site's Geofence Entry Radius. |
| | The last recorded location prior to this was outside the Service Center Site's |
| | Geofence Entry Radius Data Logger Events: |
| | The Data Logger records and reports a “12” Entry Geofence violation. |
| 9 | The Data Logger happens take a location reading that happens to still be |
| | inside the Service Center Site's Exit Radius - and happens to also be outside |
| | the Service Center Site's Entry Radius. |
| | Data Logger Events: |
| | None - because no Geofences have been violated. Going beyond the “12” |
| | Entry Geofence means nothing. |
| 10 | The Data Logger happens to take a location reading that is - for the first time |
| | on this shipment - crosses from inside to outside the Service Center Site's |
| | Geofence Exit Radius. |
| | Data Logger Events: |
| | The Data Logger records and reports a “21” Exit Geofence violation. |
| 11 | The Data Logger happens to take a location reading that is outside of all |
| | Geofence radii. |
| | Data Logger Events: |
| | None - because no Geofences have been violated. The “21” Exit Geofence |
| | violation would have been detected at Location #10. |
| 12 | The Data Logger happens to take a location reading that is outside of all |
| | Geofence radii. |
| | Data Logger Events: |
| | None - because no Geofences have been violated. The “21” Exit Geofence |
| | violation would have been detected at Location #10. |
| 13 | The Data Logger happens to take a location reading that is inside the Exit |
| | Geofence radius for the Customer Origin Site - but has not yet crossed the |
| | Entry Geofence radius for the Customer Origin Site. |
| | Data Logger Events: |
| | None - because no Geofences have been violated. |
| 14 | The Data Logger happens to take a location reading that is - for the first time |
| | on this shipment - inside the Customer Origin Site's Geofence Entry Radius. |
| | The last recorded location prior to this was outside the Customer Origin Site's |
| | Geofence Entry Radius |
| | Data Logger Events: |
| | The Data Logger records and reports a “22” Entry Geofence violation. |
| 15 | The Data Logger happens take a location reading that happens to still be |
| | inside the Customer Origin Site's Exit Radius - and happens to also be |
| | outside the Customer Origin Site's Entry Radius. |
| | Data Logger Events: |
| | None - because no Geofences have been violated. Going beyond the “22” |
| | Entry Geofence means nothing. |
| 16 | The Data Logger happens to take a location reading that is - for the first time |
| | on this shipment - crosses from inside to outside the Customer Origin Site's |
| | Geofence Exit Radius. |
| | Data Logger Events: |
| | The Data Logger records and reports a “31” Exit Geofence violation. |
| 17 | The Data Logger happens to take a location reading that is outside of all |
| | Geofence radii. |
| | Data Logger Events: |
| | None - because no Geofences have been violated. The “31” Exit Geofence |
| | violation would have been detected at Location #16. |
| 18 | The Data Logger happens to take a location reading that is outside of all |
| | Geofence radii. |
| | Data Logger Events: |
| | None - because no Geofences have been violated. The “31” Exit Geofence |
| | violation would have been detected at Location #16. |
| 19 | The Data Logger happens to take a location reading that is inside the Exit |
| | Geofence radius for the Customer Destination - but has not yet crossed the |
| | Entry Geofence radius for the Customer Destination. |
| | Data Logger Events: |
| | None - because no Geofences have been violated. |
| 20 | The Data Logger happens to take a location reading that is inside the |
| | Customer Destination's Geofence Entry Radius. The last recorded location |
| | prior to this was outside the Customer Destination's Geofence Entry Radius |
| | Data Logger Events: |
| | The Data Logger records and reports a “32” Entry Geofence violation. |
| 21 | The Data Logger happens take a location reading that happens to still be |
| | inside the Customer Destination Site's Exit Radius - and happens to also be |
| | outside the Customer Destination Site's Entry Radius. |
| | Data Logger Events: |
| | None - because no Geofences have been violated. Going beyond the “32” |
| | Entry Geofence means nothing. |
| 22 | The Data Logger happens to take a location reading that is - for the first time |
| | on this shipment - crosses from inside to outside the Customer Destination |
| | Site's Geofence Exit Radius. |
| | Data Logger Events: |
| | The Data Logger records and reports a “41” Exit Geofence violation. |
| 23 | The Data Logger happens to take a location reading that is outside of all |
| | Geofence radii. |
| | Data Logger Events: |
| | None - because no Geofences have been violated. The “41” Exit Geofence |
| | violation would have been detected at Location #22. |
| 24 | The Data Logger happens to take a location reading that is outside of all |
| | Geofence radii. |
| | Data Logger Events: |
| | None - because no Geofences have been violated. The “41” Exit Geofence |
| | violation would have been detected at Location #22. |
| 25 | The Data Logger happens to take a location reading that is inside the Exit |
| | Geofence radius for the Logistics Center - but has not yet crossed the Entry |
| | Geofence radius for the Logistics Center. |
| | Data Logger Events: |
| | None - because no Geofences have been violated. |
| 26 | The Data Logger happens to take a location reading that is inside the |
| | Logistics Center's Geofence Entry Radius. The last recorded location prior to |
| | this was outside the Logistics Center's Geofence Entry Radius. |
| | Data Logger Events: |
| | The Data Logger records and reports a “42” Entry Geofence violation. |

With reference to FIG. 13, a flowchart for a method 800 for determining whether one or more Geofences have been violated is illustrated, in accordance with various embodiments. In these or other embodiments, one or more of the activities of method 800 can be implemented as one or more computer instructions configured to run at one or more processing modules and configured to be stored at one or more non-transitory memory storage modules. Such non-transitory memory storage modules can be part of a computer system such as the data logger 10 (FIG. 1). In some embodiments, method 800 can be performed in parallel, before, after, or as a part of method 200 (FIG. 2) and/or method 900 (FIG. 14). In various embodiments, one or more activities of method 800 can be inserted into and/or combined with all of or portions of method 200 (FIG. 2) and/or method 900 (FIG. 14).

With combined reference to FIG. 1 and FIG. 13, one may appreciate that the data logger 10 thus may have logical aspects that perform different logical steps. The data logger 10 can check the location (e.g., latitude and longitude) of the shipping container 8 and determine the distance from all of the Geofence locations listed in data log tables (block 802). The data logger 10 can determine whether the shipping container 8 is inside an entry-Geofence (block 804). In response to the data logger 10 determining the shipping container 8 is inside an entry-Geofence, the data logger can determine whether the current shipment has any prior Geofence violations (block 806). If there are no prior Geofence violations for the current shipment, the data logger 10 can record and entry violation based on the current location (block 808). If there are prior Geofence violations for the current shipment, the data logger 10 can determine whether the shipping container 8 is currently inside the same entry-Geofence as the immediately prior entry Geofence violation (block 810). In response to the answer at block 810 being yes, no further action is taken. In response to the answer at block 810 being no, the data logger 10 can determine whether the previous violation is an entry violation (block 814). In response to the answer at block 814 being no, the data logger 10 can record the new entry violation (block 816). In response to the answer at block 814 being yes, the data logger 10 can record an exit violation for the previous location's exit geofence (block 818). Block 818 assumes the exit occurred, but for unknown reasons was not detected by the data logger 10 (e.g., poor network communication or the like). The data logger 10 can then proceed to block 816 where it records the present violation as a new entry violation.

Returning to block 804, in response to determining the shipping container 8 is not inside any entry Geofence, the data logger 10 can determine whether the shipping container 8 is outside of all Geofences (block 820). In response to the answer at block 820 being no, no further action may be taken. In response to the answer at block 820 being yes, the data logger 10 can determine whether this shipment had a prior Geofence activity violation (block 822). In response to the answer at block 822 being yes, the data logger 10 can further determine whether the immediately prior Geofence violation was an entry (block 824). In response to the answer at block 824 being no, no further action may be taken. In response to the answer at block 824 being yes, the data logger 10 can record an exit violation for the immediately prior Geofence entry violation (block 826).

In response to the answer at block 822 being no, the data logger can determine whether the data store (e.g., memory 14) has a record of a prior location (block 828). In response to the answer at block 828 being no, no further action may be taken. In response to the answer at block 828 being yes, the data logger can further determine whether the most recent prior location was inside an exit Geofence (block 830). In response to the answer at block 830 being no, no further action may be taken. In response to the answer at block 830 being yes, the data logger 832 can record a violation for the Geofence exit boundary just crossed by the shipping container 8.

With reference to FIG. 14, a flow chart for a method 900 of Geofence recording and reporting is illustrated, in accordance with various embodiments. With combined reference to FIG. 1 and FIG. 14, the data logger 10 can initiate a Geofence recording and reporting procedure (block 902). In various embodiments, the data logger 10 can initiate the method 900 at predetermined intervals (e.g., every second, every minute, or any other desired interval). In various embodiments, the remote monitoring unit 4 can send a command to initiate the method 900. The data logger 10 can determine whether a Geofence activity has been violated (block 904). In response to the answer at block 904 being no, the method 900 can end (block 910). In response to the answer at block 904 being yes (i.e., a Geofence activity has been violated), the data logger 10 can log and send the Geofence violation, including outstanding violations or errors if applicable, to a remote server, such as remote monitoring unit 4 for example (block 906). The data logger 10 can determine whether the Geofence violation was successfully sent to the remote server (block 908). For example, the data logger 10 can determine whether a receipt confirmation was received from the remote server. In response to the answer at block 908 being no, the data logger 10 can log a data communication error (block 912). In response to the answer at block 910 being yes, the method can end (block 910).

While the detailed discussion of the systems, methods, and apparatuses is concluded, it is also helpful to provide a brief summary in the following concluding paragraphs. For instance, in various embodiments, a method is provided. The method can be for electronically tracking a shipment. The method includes gathering a Geofence boundary. The method further includes determining a present location of a shipping container relative to the Geofence boundary. The method further includes determining a last known location of the shipping container relative to the Geofence boundary. The method further includes, in response to determining that the last known location is outside the entry radius and the present location is inside the entry radius, recording a Geofence entry violation and transmitting the Geofence entry violation to a remote monitoring unit. The method further includes, in response to determining that the last known location is inside an exit radius of the Geofence and the present location is outside the exit radius of the Geofence, recording a Geofence exit violation and transmitting the Geofence exit violation to a remote monitoring unit.

In various embodiments, the Geofence boundary can be stored in a memory. The Geofence boundary can include a latitude, a longitude, an entry radius, and an exit radius. The present location can be received from a GPS sensor located onboard the shipping container. The entry radius can be different (e.g., smaller) from the exit radius.

The method can further include, in response to determining that the shipping container is currently inside a Geofence entry radius, determining whether the shipment has any prior Geofence violations. The method can further include, in response to determining that the shipment has a prior Geofence violation, determining whether the shipping container is inside the same Geofence as an immediately prior Geofence violation. The method can further include, in response to determining that the Geofence is not inside the same Geofence as the immediately prior Geofence violation, determining whether the immediately prior Geofence violation was an entry violation. The method can further include, in response to determining that the immediately prior Geofence violation was not an entry violation, recording a new Geofence entry violation. The method can further include, in response to determining that the immediately prior Geofence violation was an entry violation, recording a Geofence exit violation for a Geofence of the immediately prior Geofence violation, and recording the new Geofence entry violation.

In various embodiments, the method can further include, in response to determining that the shipping container is not currently inside a Geofence entry radius, determining whether the shipping container is outside all known Geofences. The method can further include, in response to determining that the shipping container is currently outside all known Geofences, determining whether the shipment has any prior Geofence violations. The method can further include, in response to determining that the shipment has a prior Geofence violation, determining whether an immediately prior Geofence violation is an entry violation. The method can further include, in response to determining that the immediately prior Geofence violation was an entry violation, recording a new Geofence exit violation for the immediately-prior Geofence violation.

The method can further include, in response to determining that the shipment does not have a prior Geofence violation, determining whether a previous location for the shipping container is stored in memory. The method can further include, in response to determining that a previous location for the shipping container is stored in memory, determining whether a most-recent prior location is inside a Geofence exit radius. The method can further include, in response to determining that the most-recent prior location is inside the Geofence exit radius, recording a Geofence exit violation for the Geofence exit radius.

A computer-readable storage medium is also disclosed. The computer-readable storage medium can store instructions that, when executed by a computer, cause the computer to perform a method for using a computer system to electronically track a shipping container during shipment. The method includes gathering a Geofence boundary, determining a present location of a shipping container relative to the Geofence boundary, and determining a last known location of the shipping container relative to the Geofence boundary. The method can further include, in response to determining that the last known location is outside the entry radius and the present location is inside the entry radius, recording a Geofence entry violation and transmitting the Geofence entry violation to a remote monitoring unit. The method can further include, in response to determining that the last known location is inside an exit radius of the Geofence and the present location is outside the exit radius of the Geofence, recording a Geofence exit violation and transmitting the Geofence exit violation to a remote monitoring unit.

In another aspect of the present disclosure, a method of electronically tracking a shipment includes receiving, by a data logger, a first location of a shipping container from a location sensor. The method can further include receiving, by the data logger, a second location of the shipping container from the location sensor. The method can further include gathering, by the data logger, a first Geofence data from a memory, the first Geofence data including an entry radius of a first Geofence and an exit radius of the first Geofence. The method can further include determining, by the data logger, that the first location is outside the entry radius of the first Geofence and the second location is inside the entry radius of the first Geofence. The method can further include recording, by the data logger, a first Geofence entry violation to the memory. The method can further include transmitting, by the data logger, the first Geofence entry violation to a remote monitoring unit.

The method can further include receiving, by the data logger, a third location of the shipping container from the location sensor, determining, by the data logger, that the third location is outside the exit radius of the first Geofence and a fourth location received immediately prior to the third location is inside the exit radius of the first Geofence, recording, by the data logger, a first Geofence exit violation to the memory, and transmitting, by the data logger, the first Geofence exit violation to the remote monitoring unit.

The method can further include receiving, by the data logger, a fifth location of the shipping container from the location sensor, determining, by the data logger, that the fifth location is inside the entry radius of a second Geofence and a sixth location received immediately prior to the fifth location is outside the entry radius of the second Geofence, recording, by the data logger, a second Geofence entry violation to the memory, and transmitting, by the data logger, the second Geofence entry violation to the remote monitoring unit.

The method can further include sending, by the remote monitoring unit, the first Geofence data to the data logger.

In various embodiments, the entry radius of the first Geofence is less than the exit radius of the first Geofence.

The method can further include performing an action in response to a Geofence activity violation. For example, the method can further include switching the data logger to an Aircraft Mode in response to determining, by the data logger, that the first location is outside the entry radius of the first Geofence and the second location is inside the entry radius of the first Geofence.

The detailed description of exemplary embodiments herein refers to the accompanying drawings and pictures, which show various embodiments by way of illustration. While these various embodiments are described in sufficient detail to enable those skilled in the art to practice the disclosure, it should be understood that other embodiments may be realized, and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a range of “less than 10” includes any and all subranges between (and including) the minimum value of zero and the maximum value of 10, that is, any and all subranges having a minimum value of equal to or greater than zero and a maximum value of equal to or less than 10, e.g., 1 to 5.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. Reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each, and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is intended to invoke 35 U.S.C. § 112 (f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method of electronically tracking a shipment, the method comprising:
gathering a Geofence boundary;
determining a present location of a shipping container relative to the Geofence boundary;
determining a last known location of the shipping container relative to the Geofence boundary;
in response to determining that the last known location is outside an entry radius of the Geofence boundary and the present location is inside the entry radius, recording a Geofence entry violation and transmitting the Geofence entry violation to a remote monitoring unit; and
in response to determining that the last known location is inside an exit radius of the Geofence boundary and the present location is outside the exit radius of the Geofence boundary, recording a Geofence exit violation and transmitting the Geofence exit violation to the remote monitoring unit.

2. The method according to claim 1, wherein the Geofence boundary is stored in a memory and includes a latitude, a longitude, the entry radius, and the exit radius.

3. The method according to claim 2, wherein the present location is received from a GPS sensor located onboard the shipping container.

4. The method according to claim 2, wherein the entry radius is different from the exit radius.

5. The method according to claim 1, further comprising:
in response to determining that the shipping container is currently inside a Geofence entry radius, determining whether the shipment has any prior Geofence violations;
in response to determining that the shipment has a prior Geofence violation, determining whether the shipping container is inside the same Geofence as an immediately prior Geofence violation;
in response to determining that the Geofence is not inside the same Geofence as the immediately prior Geofence violation, determining whether the immediately-prior Geofence violation was an entry violation;
in response to determining that the immediately prior Geofence violation was not an entry violation, recording a new Geofence entry violation; and
in response to determining that the immediately prior Geofence violation was an entry violation, recording a Geofence exit violation for a Geofence of the immediately-prior Geofence violation, and recording the new Geofence entry violation.

6. The method according to claim 1, further comprising:
in response to determining that the shipping container is not currently inside a Geofence entry radius, determining whether the shipping container is outside all known Geofences;
in response to determining that the shipping container is currently outside all known Geofences, determining whether the shipment has any prior Geofence violations;
in response to determining that the shipment has a prior Geofence violation, determining whether an immediately prior Geofence violation is an entry violation; and
in response to determining that the immediately prior Geofence violation was an entry violation, recording a new Geofence exit violation for the immediately-prior Geofence violation.

7. The method according to claim 6, further comprising:
in response to determining that the shipment does not have a prior Geofence violation, determining whether a previous location for the shipping container is stored in memory;
in response to determining that the previous location for the shipping container is stored in memory, determining whether a most-recent prior location is inside a Geofence exit radius; and
in response to determining that the most-recent prior location is inside the Geofence exit radius, recording a Geofence exit violation for the Geofence exit radius.

8. A computer-readable storage medium storing instructions that when executed by a computer cause the computer to perform a method for using a computer system to electronically track a shipping container during shipment, the method comprising:
gathering a Geofence boundary;
determining a present location of the shipping container relative to the Geofence boundary;
determining a last known location of the shipping container relative to the Geofence boundary;
in response to determining that the last known location is outside an entry radius of the Geofence boundary and the present location is inside the entry radius, recording a Geofence entry violation and transmitting the Geofence entry violation to a remote monitoring unit; and
in response to determining that the last known location is inside an exit radius of the Geofence boundary and the present location is outside the exit radius of the Geofence boundary, recording a Geofence exit violation and transmitting the Geofence exit violation to the remote monitoring unit.

9. The computer-readable storage medium according to claim 8, wherein the Geofence boundary is stored in a memory and includes a latitude, a longitude, the entry radius, and the exit radius.

10. The computer-readable storage medium according to claim 9, wherein the present location is received from a GPS sensor located onboard the shipping container.

11. The computer-readable storage medium according to claim 9, wherein the entry radius is different from the exit radius.

12. The computer-readable storage medium according to claim 8, wherein the method further comprises:
in response to determining that the shipping container is currently inside a Geofence entry radius, determining whether the shipment has any prior Geofence violations;
in response to determining that the shipment has a prior Geofence violation, determining whether the shipping container is inside the same Geofence as an immediately prior Geofence violation;
in response to determining that the shipping container is not inside the same Geofence as the immediately prior Geofence violation, determining whether the immediately-prior Geofence violation was an entry violation;
in response to determining that the immediately prior Geofence violation was not an entry violation, recording a new Geofence entry violation; and
in response to determining that the immediately prior Geofence violation was an entry violation, recording a Geofence exit violation for a Geofence of the immediately-prior Geofence violation, and recording the new Geofence entry violation.

13. The computer-readable storage medium according to claim 8, wherein the method further comprises:
in response to determining that the shipping container is not currently inside a Geofence entry radius, determining whether the shipping container is outside all known Geofences;
in response to determining that the shipping container is currently outside all known Geofences, determining whether the shipment has any prior Geofence violations;
in response to determining that the shipment has a prior Geofence violation, determining whether an immediately prior Geofence violation is an entry violation; and
in response to determining that the immediately prior Geofence violation was an entry violation, recording a new Geofence exit violation for the immediately-prior Geofence violation.

14. The computer-readable storage medium according to claim 13, wherein the method further comprises:
in response to determining that the shipment does not have a prior Geofence violation, determining whether a previous location for the shipping container is stored in memory;
in response to determining that a previous location for the shipping container is stored in memory, determining whether a most-recent prior location is inside a Geofence exit radius; and
in response to determining that the most-recent prior location is inside the Geofence exit radius, recording a Geofence exit violation for the Geofence exit radius.

15. A method of electronically tracking a shipment, the method comprising:
receiving, by a data logger, a first location of a shipping container from a location sensor;
receiving, by the data logger, a second location of the shipping container from the location sensor;
gathering, by the data logger, a first Geofence data from a memory, the first Geofence data including an entry radius of a first Geofence and an exit radius of the first Geofence;
determining, by the data logger, that the first location is outside the entry radius of the first Geofence and the second location is inside the entry radius of the first Geofence;
recording, by the data logger, a first Geofence entry violation to the memory; and
transmitting, by the data logger, the first Geofence entry violation to a remote monitoring unit.

16. The method according to claim 15, further comprising:
receiving, by the data logger, a third location of the shipping container from the location sensor;
determining, by the data logger, that the third location is outside the exit radius of the first Geofence and a fourth location received immediately prior to the third location is inside the exit radius of the first Geofence;
recording, by the data logger, a first Geofence exit violation to the memory; and
transmitting, by the data logger, the first Geofence exit violation to the remote monitoring unit.

17. The method according to claim 16, further comprising:
receiving, by the data logger, a fifth location of the shipping container from the location sensor;
determining, by the data logger, that the fifth location is inside the entry radius of a second Geofence and a sixth location received immediately prior to the fifth location is outside the entry radius of the second Geofence;
recording, by the data logger, a second Geofence entry violation to the memory; and
transmitting, by the data logger, the second Geofence entry violation to the remote monitoring unit.

18. The method according to claim 15, further comprising sending, by the remote monitoring unit, the first Geofence data to the data logger.

19. The method according to claim 15, wherein the entry radius of the first Geofence is less than the exit radius of the first Geofence.

20. The method according to claim 15, further comprising switching the data logger to an Aircraft Mode in response to determining, by the data logger, that the first location is outside the entry radius of the first Geofence and the second location is inside the entry radius of the first Geofence.
